(19) United States
(12) Patent Application Publication
(10) Pub. No.: US 2024/0397041 A1
(43) Pub. Date: Nov. 28, 2024

(54) VIDEO DECODING APPARATUS AND VIDEO CODING APPARATUS

(71) Applicant: SHARP KABUSHIKI KAISHA, Sakai City, Osaka (JP)

(72) Inventors: YUKINOBU YASUGI, Sakai City, Osaka (JP); TOMOHIRO IKAI, Sakai City, Osaka (JP); TOMOKO AONO, Sakai City, Osaka (JP); TOMONORI HASHIMOTO, Sakai City, Osaka (JP)

(21) Appl. No.: 18/693,466

(22) PCT Filed: Sep. 21, 2022
(86) PCT No.: PCT/JP2022/035113

§ 371 Date: Mar. 19, 2024

(30) Foreign Application Priority Data
Sep. 24, 2021 (JP) 2021-155022
Dec. 9, 2021 (JP) 2021-199765

(51) Int. Cl. H04N 19/11; H04N 19/105; H04N 19/124; H04N 19/132; H04N 19/176

(52) U.S. Cl. CPC H04N 19/11; H04N 19/105; H04N 19/124; H04N 19/132; H04N 19/176

(57) ABSTRACT

A video decoding apparatus includes a matrix reference pixel derivation unit that derives, as a reference image, an image obtained by downsampling an image adjacent to a top side and a left side of a target block,
a mode derivation unit that derives a candidate list of prediction modes used for a target block according to the reference image and a size of the target block, a prediction processing parameter derivation unit that derives a prediction processing parameter used to derive a prediction image according to the candidate list, a matrix intra prediction mode indicator, and the size of the target block, a matrix prediction image derivation unit that derives a prediction image based on an element of the reference image and the prediction processing parameter, and
a matrix prediction image interpolation unit that derives the prediction image or an image obtained by interpolating the prediction image, as a prediction image. The mode derivation unit derives a candidate list having a number of elements equal to or less than half a total number of prediction modes defined for the size of the target block.

### TECHNICAL FIELD

An embodiment of the present invention relates to a video decoding apparatus and a video coding apparatus.

### BACKGROUND ART

A video coding apparatus which generates coded data by encoding a video, and a video decoding apparatus which generates decoded images by decoding the coded data are used for efficient transmission or recording of videos.

For example, specific video coding schemes include schemes proposed in, for example, H.264/AVC and High-Efficiency Video Coding (HEVC), and the like.

In such a video coding scheme, images (pictures) constituting a video are managed in a hierarchical structure including slices obtained by splitting an image, Coding Tree Units (CTUs) obtained by splitting a slice, units of coding (which may also be referred to as Coding Units (CUs)) obtained by splitting a coding tree unit, and Transform Units (TUs) obtained by splitting a coding unit, and are coded/decoded for each CU.

In addition, in such a video coding scheme, usually, a prediction image is generated based on a local decoded image that is obtained by coding/decoding an input image (a source image), and prediction errors (which may be referred to also as “difference images” or “residual images”) obtained by subtracting the prediction image from the input image are coded. Generation methods of prediction images include an inter-picture prediction (inter prediction) and an intra-picture prediction (intra prediction).

In addition, NPL 1 is taken as an example of the recent technology for video coding and decoding. NPL 1 discloses a Matrix-based Intra Prediction (MIP) technique for deriving a prediction image by performing a product-sum operation of a reference image derived from an adjacent image and a weight matrix.

### CITATION LIST

### Non Patent Literature

NPL 1: ITU-T Rec. H.266

### SUMMARY OF INVENTION

### Technical Problem

In the matrix intra prediction as described in NPL 1, since a prediction image is generated by selecting an appropriate matrix from a plurality of matrices defined in advance, there is a problem that the amount of coded data for selecting a matrix, that is, the amount of data in a matrix intra prediction mode, increases. In addition, in the matrix intra prediction as described in NPL 1, reference pixels are limited to pixels adjacent to a target block, and thus prediction performance is not satisfactory. Therefore, when the range of adjacent pixels is enlarged, it is expected that a better prediction image will be obtained. However, on the other hand, there is a problem that the calculation amount of matrix operation increases if an amount of input data is simply increased.

An object of the present invention is to perform suitable matrix intra prediction in a matrix intra prediction mode while reducing a data amount or without greatly increasing the calculation amount of a matrix operation.

### Solution to Problem

To solve the above-described problem, a video decoding apparatus according to an aspect of the present invention includes
a matrix reference pixel derivation unit that derives, as a reference image, an image obtained by downsampling an image adjacent to a top side and a left side of a target block,
a mode derivation unit that derives a candidate list of prediction modes used for a target block according to the reference image and a size of the target block,
a prediction processing parameter derivation unit that derives a prediction processing parameter used to derive a prediction image according to the candidate list, a matrix intra prediction mode indicator, and the size of the target block,
a matrix prediction image derivation unit that derives a prediction image based on an element of the reference image and the prediction processing parameter, and
a matrix prediction image interpolation unit that derives the prediction image or an image obtained by interpolating the prediction image as a prediction image,
in which the mode derivation unit derives a candidate list having the number of elements equal to or less than half a total number of prediction modes defined for the size of the target block.

To solve the above-described problem, a video decoding apparatus according to an aspect of the present invention includes
a matrix reference pixel derivation unit that derives, as a reference image, an image obtained by downsampling an image adjacent to a top side and a left side of a target block,
a prediction processing parameter derivation unit that derives a parameter used to derive a prediction image according to a matrix intra prediction mode and a size of the target block,
a matrix prediction image derivation unit that derives a prediction image based on an element of the reference image and the prediction processing parameter, and
a matrix prediction image interpolation unit that derives the prediction image or an image obtained by interpolating the prediction image as a prediction image,
in which a reference image or a downsampling method is switched according to a parameter obtained from coded data.

### Advantageous Effects of Invention

According to one aspect of the present invention, it is possible to perform suitable intra prediction while reducing the amount of data or without increasing the amount of calculation in a matrix intra prediction mode.

### BRIEF DESCRIPTION OF DRAWINGS

FIG. 1 is a schematic diagram illustrating a configuration of an image transmission system according to the present embodiment.

FIG. 2 is a diagram illustrating a hierarchical structure of data of a coding stream.

FIG. 3 is a schematic diagram illustrating types (mode numbers) of intra prediction modes.

FIG. 4 is a schematic diagram illustrating a configuration of a video decoding apparatus.

FIG. 5 is a diagram illustrating a reference region used for intra prediction.

FIG. 6 is a diagram illustrating a configuration of an intra prediction image generation unit.

FIG. 7 is a diagram illustrating a MIP unit in detail.

FIG. 8 is a diagram illustrating the MIP unit in detail.

FIG. 9 is an example of syntax of MIP.

FIG. 10 is a diagram illustrating examples of a reference region of MIP.

FIG. 11 is a diagram illustrating examples of a reference region of MIP.

FIG. 12 is a diagram illustrating examples of a reference region of MIP.

FIG. 13 is a diagram illustrating examples of a reference region of MIP.

FIG. 14 is a diagram illustrating an example of MIP processing.

FIG. 15 is a diagram illustrating an example of MIP processing.

FIG. 16 is a diagram illustrating an example of a reference region of MIP.

FIG. 17 is a block diagram illustrating a configuration of a video coding apparatus.

### DESCRIPTION OF EMBODIMENTS

### First Embodiment

Hereinafter, an embodiment of the present invention will be described with reference to the drawings.

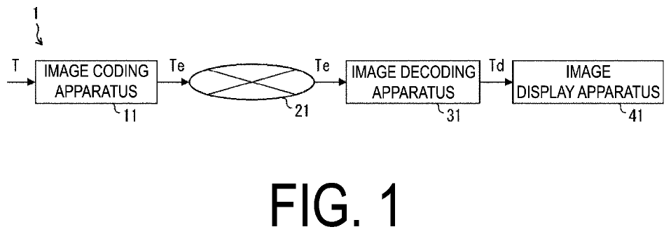

FIG. 1 is a schematic diagram illustrating a configuration of an image transmission system 1 according to the present embodiment.

The image transmission system 1 is a system in which a coding stream obtained by coding a coding target image is transmitted, the transmitted coding stream is decoded, and thus an image is displayed. The image transmission system 1 includes a video coding apparatus (image coding apparatus) 11, a network 21, a video decoding apparatus (image decoding apparatus) 31, and a video display apparatus (image display apparatus) 41.

An image T is input to the video coding apparatus 11.

The network 21 transmits a coding stream Te generated by the video coding apparatus 11 to the video decoding apparatus 31. The network 21 is the Internet, a Wide Area Network (WAN), a Local Area Network (LAN), or a combination thereof. The network 21 is not necessarily limited to a bi-directional communication network, and may be a unidirectional communication network configured to transmit broadcast waves of digital terrestrial television broadcasting, satellite broadcasting, or the like. In addition, the network 21 may be replaced by a storage medium on which the coding stream Te is recorded, such as a Digital Versatile Disc (DVD) (trade name) or a Blu-ray Disc (BD) (trade name).

The video decoding apparatus 31 decodes each of the coding streams Te transmitted from the network 21 and generates one or multiple decoded images Td.

The video display apparatus 41 displays all or part of one or multiple decoded images Td generated by the video decoding apparatus 31. For example, the video display apparatus 41 includes a display device such as a liquid crystal display and an organic Electro-luminescence (EL) display. Forms of the display include a stationary type, a mobile type, an HMD type, and the like. In addition, in a case that the video decoding apparatus 31 has a high processing capability, an image having high image quality is displayed, and in a case that the video decoding apparatus has a lower processing capability, an image which does not require high processing capability and display capability is displayed.

### Operator

Operators used in the present specification will be described below.

>>represents a right bit shift, <<represents a left bit shift, & represents a bitwise AND, | represents a bitwise OR, |=represents an OR assignment operator, && represents a logical product (AND), and ∥ represents a logical sum (OR).

“x?y: z” represents a ternary operator that takes y if x is true (not 0) and z if x is false (0).

Clip3(a, b, c) is a function to clip c to a value equal to or greater than a and less than or equal to b, and a function to return a in a case that c is less than a (c<a), return b in a case that c is greater than b (c>b), and return c in other cases (provided that a is less than or equal to b (a<=b)).

Clip1Y(c) is an operator set to a=0 and b=(1<<BitDepthY)−1 in Clip3 (a, b, c). BitDepthY is a bit dept of luminance.

abs(a) is a function that returns the absolute value of a.

Int(a) is a function that returns an integer value of a.

Floor(a) is a function that returns the maximum integer equal to or less than a.

Ceil(a) is a function that returns the minimum integer equal to or greater than a.

a/d represents division of a by d (rounded down to decimal point).

Min(a, b) is a function that returns the smaller value between a and b.

### Structure of Coding Stream Te

Prior to the detailed description of the video coding apparatus 11 and the video decoding apparatus 31 according to the present embodiment, a data structure of the coding stream Te generated by the video coding apparatus 11 and decoded by the video decoding apparatus 31 will be described.

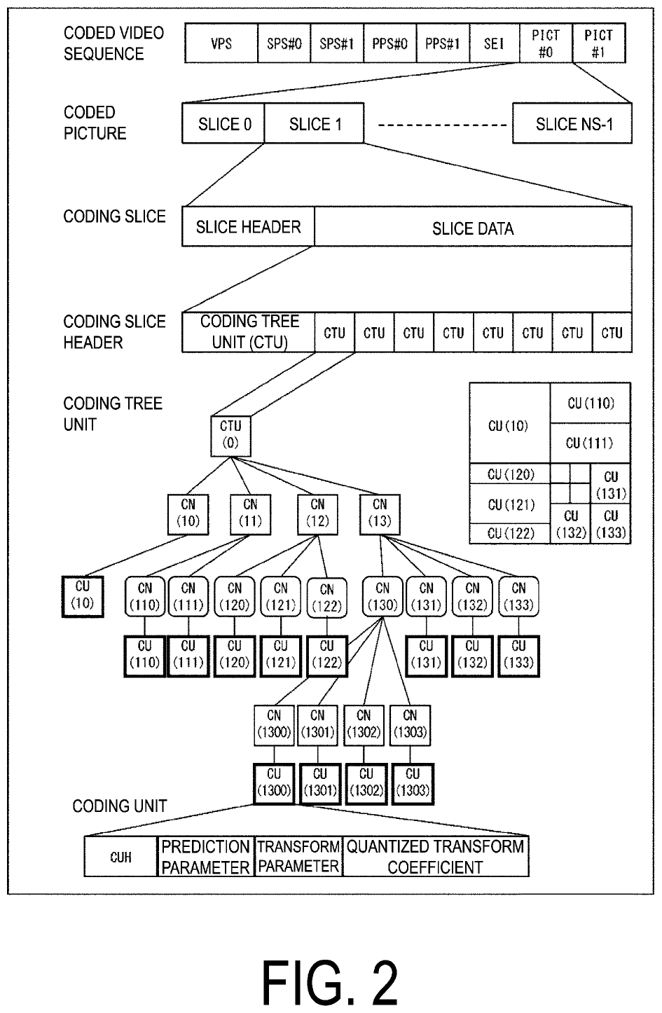

FIG. 2 is a diagram illustrating a hierarchical structure of data of the coding stream Te. The coding stream Te includes, as an example, a sequence and a plurality of pictures constituting the sequence. FIG. 2 illustrates a coded video sequence that defaults to a sequence SEQ, a coded picture that defines a picture PICT, a coding slice that defines a slice S, coding slice data that defines slice data, coding tree units included in coding slice data, and coding units included in each coding tree unit.

### Coded Video Sequence

In the coded video sequence, a set of data referred to by the video decoding apparatus 31 to decode a sequence SEQ to be processed is defined. As illustrated in the coded video sequence of FIG. 2, the sequence SEQ includes a Video Parameter Set (VPS), Sequence Parameter Sets (SPSs), Picture Parameter Sets (PPSs), pictures PICT, and Supplemental Enhancement Information (SEI).

The video parameter set VPS defines, in a video composed of a plurality of layers, a set of coding parameters common to a plurality of video images and a set of coding parameters relating to a plurality of layers and individual layers included in the video.

In the sequence parameter sets SPSs, a set of coding parameters referred to by the video decoding apparatus 31 to decode a target sequence is defined. For example, a width and a height of a picture are defined. Further, multiple SPSs may exist. In that case, any of the multiple SPSs is selected from the PPS.

In the picture parameter sets (PPS), a set of coding parameters that the video decoding apparatus 31 refers to in order to decode each picture in the target sequence s defined. For example, a PPS includes a reference value for a quantization step size used in picture decoding (pic_init_qp_minus26) and a flag indicating application of weighted prediction (weighted pred_flag). Further, multiple PPSs may exist. In that case, any of the multiple PPSs is selected from each picture in a target sequence.

### Coded Picture

In the coded picture, a set of data referred to by the video decoding apparatus 31 to decode a picture PICT to be processed is defined. As illustrated in the coded picture of FIG. 2, a picture PICT includes slices 0 to NS−1 (where NS is the total number of slices included in the picture PICT).

Further, in a case that it is not necessary to distinguish each of the slice 0 to the slice NS−1 below, numeric suffixes of reference signs may be omitted. In addition, the same applies to other data with suffixes included in the coding stream Te which will be described below.

### Coding Slice

In each coding slice, a set of data referred to by the video decoding apparatus 31 to decode a slice S to be processed is defined. Each slice includes a slice header and slice data as illustrated in the coding slice of FIG. 2.

The slice header includes a coding parameter group referred to by the video decoding apparatus 31 to determine a decoding method for a target slice. Slice type indication information (slice_type) indicating a slice type is one example of a coding parameter included in the slice header.

Examples of slice types that can be indicated by the slice type indication information include (1) an I slice for which only intra prediction is used for coding, (2) a P slice for which unidirectional prediction or intra prediction is used for coding, (3) a B slice for which unidirectional prediction, bidirectional prediction, or intra prediction is used for coding. Further, the inter prediction is not limited to a uni-prediction and a bi-prediction, and a prediction image may be generated by using a larger number of reference pictures. Hereinafter, in a case that a slice is referred to as a P or B slice, a slice that includes a block in which inter prediction can be used is indicated.

Further, the slice header may include a reference to the picture parameter set PPS (pic_parameter_set_id).

### Coding Slice Data

In coding slice data, a set of data referred to by the video decoding apparatus 31 to decode slice data to be processed is defined. Slice data includes CTUs as illustrated in the coding slice header of FIG. 2. A CTU is a block having a fixed size (e.g., 64×64) constituting a slice, and may also be called a Largest Coding Unit (LCU).

### Coding Tree Unit

In the coding tree unit of FIG. 2, a set of data that is referred to by the video decoding apparatus 31 to decode the CTU to be processed is defined. A CTU is split into coding units CU which are basic coding processing units through recursive Quad Tree (QT) splitting, Binary Tree (BT) splitting, or Ternary Tree (TT) splitting. The BT splitting and the TT splitting are collectively referred to as Multi Tree (MT) splitting. Nodes of a tree structure obtained by recursive quad tree splitting are referred to as Coding Nodes. Intermediate nodes of a quad tree, a binary tree, and a ternary tree are coding nodes, and the CTU itself is also defined as the highest coding node.

The CT includes, as CT information, a QT split flag (cu_split_flag) indicating whether to perform QT splitting, an MT split flag (split_mt_flag) indicating the presence or absence of MT splitting, an MT split direction (split_mt_dir) indicating a split direction of MT splitting, and an MT split type (split_mt_type) indicating the split type of MT splitting. cu_split_flag, split_mt_flag, split_mt_dir, and split_mt_type are transmitted for each coding node.

Furthermore, in a case that a size of a CTU is 64×64 pixels, a size of a CU may take any of 64×64 pixels, 64×32 pixels, 32×64 pixels, 32× 32 pixels, 64×16 pixels, 16×64 pixels, 32×16 pixels, 16×32 pixels, 16×16 pixels, 64×8 pixels, 8×64 pixels, 32× 8 pixels, 8×32 pixels, 16×8 pixels, 8×16 pixels, 8×8 pixels, 64×4 pixels, 4×64 pixels, 32× 4 pixels, 4×32 pixels, 16×4 pixels, 4×16 pixels, 8×4 pixels, 4×8 pixels, and 4×4 pixels.

### Coding Unit

As illustrated in the coding unit of FIG. 2, a set of data referred to by the video decoding apparatus 31 to decode the coding unit to be processed is defined. Specifically, the CU includes a CU header CUH, a prediction parameter, a transform parameter, a quantized transform coefficient, and the like. In the CU header, a prediction mode and the like are defined.

There are cases that the prediction processing is performed in units of CUs or performed in units of sub-CUs obtained by further splitting the CU. In a case that the sizes of a CU and a sub-CU are equal to each other, the number of sub-CUs in the CU is one. In a case that a CU is larger in size than a sub-CU, the CU is split into sub-CUs. For example, in a case that the CU has a size of 8×8, and the sub-CU has a size of 4×4, the CU is split into four sub-CUs including two sub-CUs split horizontally and two sub-CUs split vertically.

There are two types of predictions (prediction modes), which are intra prediction and inter prediction. Intra prediction refers to prediction in an identical picture, and inter prediction refers to prediction processing performed between different pictures (e.g., between pictures of different display times, and between pictures of different layer images).

Although transform and quantization processing is performed in units of CUs, the quantized transform coefficient may be subjected to entropy coding in units of 4×4 subblocks.

### Prediction Parameters

A prediction image is derived by prediction parameters associated with blocks. The prediction parameters include intra prediction and inter prediction parameters.

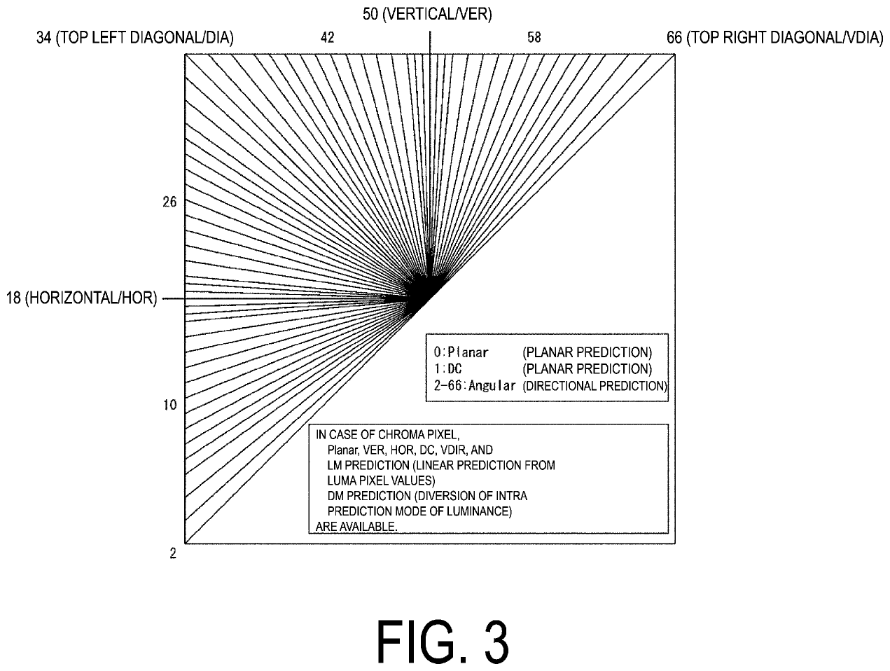

The prediction parameters for intra prediction will be described below. The intra prediction parameters include a luma prediction mode IntraPredModeY and a chroma prediction mode IntraPredModeC. FIG. 3 is a schematic diagram illustrating types (mode numbers) of intra prediction modes. There are 67 types (0 to 66) intra prediction modes, for example, as illustrated in the drawing. For example, there are planar prediction (0), DC prediction (1), and angular prediction (2 to 66). Furthermore, for chroma, an LM mode may be added.

Syntax elements for deriving the intra prediction parameters include, for example, intra_luma_mpm_flag, intra_luma_mpm_idx, intra_luma_mpm_remainder, and the like.

### MPM

intra_luma_mpm_flag is a flag indicating whether IntraPredModeY of a target block matches a Most Probable Mode (MPM). The MPM is a prediction mode included in an MPM candidate list mpmCandList[ ]. The MPM candidate list is a list that stores candidates that are inferred to have high probability of being applied to the target block, based on the intra prediction mode of a neighboring block and a prescribed intra prediction mode. In a case that intra_luma_mpm_flag is 1, IntraPredModeY of the target block is derived by using the MPM candidate list and the index intra_luma_mpm_idx.
IntraPredMode Y=mpmCandList[intra_luma_mpm_idx]

### REM

In a case that intra_luma_mpm_flag is 0, an intra prediction mode is selected from the mode RemIntraPredMode, which remains after removing the intra prediction mode included in the MPM candidate list from all intra prediction modes. The intra prediction mode which is selectable as RemIntraPredMode is referred to as a “non-MPM” or a “REM”. RemIntraPredMode is derived using intra_luma_mpm_remainder.

### Configuration of Video Decoding Apparatus

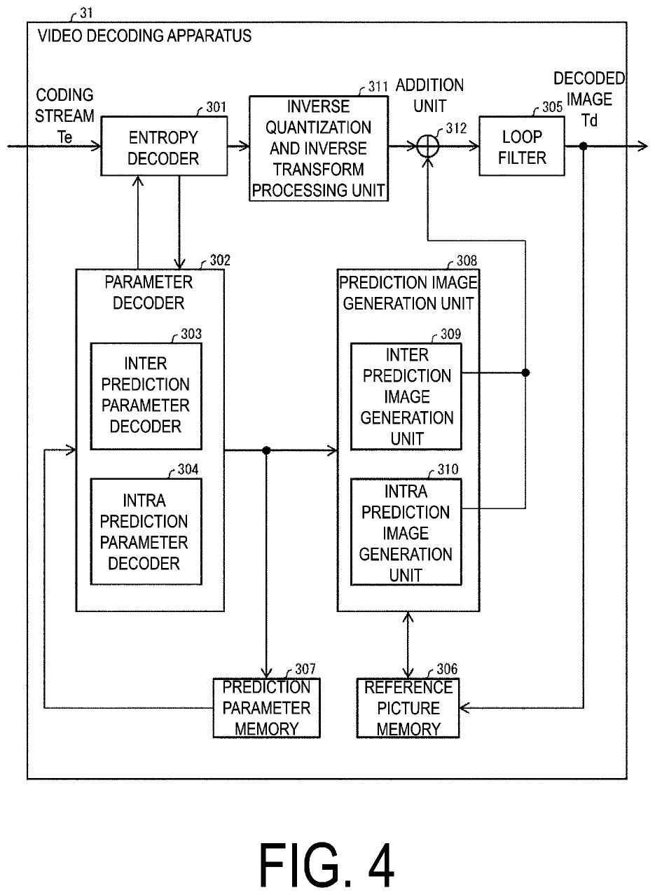

A configuration of the video decoding apparatus 31 (FIG. 4) according to the present embodiment will be described.

The video decoding apparatus 31 includes an entropy decoder 301, a parameter decoder (a prediction image decoding apparatus) 302, a loop filter 305, a reference picture memory 306, a prediction parameter memory 307, a prediction image generation unit (prediction image generation apparatus) 308, an inverse quantization and inverse transform processing unit 311, and an addition unit 312. Further, a configuration in which the loop filter 305 is not included in the video decoding apparatus 31 may be used in accordance with the video coding apparatus 11 described below.

In addition, the parameter decoder 302 includes an inter prediction parameter decoder 303 and an intra prediction parameter decoder 304 which are not illustrated. The prediction image generation unit 308 includes an inter-prediction image generation unit 309 and an intra prediction image generation unit 310.

In addition, although an example in which CTUs and CUs are used as processing units will be described below, the processing is not limited to this example, and processing in units of sub-CUs may be performed. Alternatively, the CTU and the CU may be interpreted as a block and the sub-CU as a subblock, and processing may be performed in units of blocks or subblocks.

The entropy decoder 301 performs entropy decoding on the coding stream Te input from the outside and separates and decodes individual codes (syntax elements). The entropy coding includes a scheme in which syntax elements are subjected to variable-length coding by using a context (probability model) that is adaptively selected according to a type of the syntax elements and a surrounding condition, and a scheme in which syntax elements are subjected to variable-length coding by using a table or a calculation expression determined in advance. In the former Context Adaptive Binary Arithmetic Coding (CABAC), probability models updated for each coded or decoded picture (slice) are stored in a memory. Then, as the initial state of the context of a P picture or a B picture, the probability model of a picture using quantization parameters of the same slice type and the same slice level is configured out of the probability models stored in the memory. The initial state is used for coding and decoding processing. The separated codes include prediction information to generate a prediction image, a prediction error to generate a difference image, and the like.

The entropy decoder 301 outputs the separated codes to the parameter decoder 302. Which code is to be decoded is controlled based on an indication of the parameter decoder 302.

### Configuration of Intra Prediction Parameter Decoder 304

The intra prediction parameter decoder 304 decodes an intra prediction parameter, for example, an intra prediction mode IntraPredMode, with reference to the prediction parameters stored in the prediction parameter memory 307 based on codes input from the entropy decoder 301. The intra prediction parameter decoder 304 outputs the decoded intra prediction parameter to the prediction image generation unit 308, and also stores the decoded intra prediction parameter in the prediction parameter memory 307. The intra prediction parameter decoder 304 may derive different intra prediction modes depending on luminance and chrominance.

The intra prediction parameter decoder 304 includes a MIP parameter decoder 3041, a luma intra prediction parameter decoder 3042, and a chroma intra prediction parameter decoder 3043. MIP is an abbreviation for Matrix-based Intra Prediction.

The MIP parameter decoder 3041 decodes intra_mip_flag from the coded data. In a case that intra_mip_flag is 0 and intra_luma_mpm_flag is 1, intra_luma_mpm_idx is decoded. In addition, in a case that intra_luma_mpm_flag is 0, intra_luma_mpm_remainder is decoded. Then, IntraPredModeY is derived with reference to mpmCandList[ ], intra_luma_mpm_idx, and intra_luma_mpm_remainder, and is output to the intra prediction image generation unit 310.

In addition, the chroma intra prediction parameter decoder 3043 derives IntraPredModeC from the syntax element of the intra prediction parameter of chrominance, and outputs IntraPredModeC to the intra prediction image generation unit 310.

The loop filter 305 is a filter provided in the coding loop, and is a filter that removes block distortion and ringing distortion and improves image quality. The loop filter 305 applies a filter such as a deblocking filter, a Sample Adaptive Offset (SAO), and an Adaptive Loop Filter (ALF) to a decoded image of a CU generated by the addition unit 312.

The reference picture memory 306 stores the decoded image of the CU generated by the addition unit 312 in a predetermined position for each target picture and target CU.

The prediction parameter memory 307 stores a prediction parameter in a position predetermined for each CTU or CU to be decoded. Specifically, the prediction parameter memory 307 stores the parameter decoded by the parameter decoder 302, the prediction mode predMode separated by the entropy decoder 301, and the like.

The prediction mode predMode, the prediction parameter, and the like are input to the prediction image generation unit 308. In addition, the prediction image generation unit 308 reads a reference picture from the reference picture memory 306. The prediction image generation unit 308 generates a prediction image of a block or a subblock by using the prediction parameter and the read reference picture (reference picture block) in the prediction mode indicated by the prediction mode predMode. Here, the reference picture block refers to a set of pixels (referred to as a block because they are normally rectangular) on a reference picture and is a region that is referred to for generating a prediction image.

### Intra Prediction Image Generation Unit 310

In a case that the prediction mode predMode indicates an intra prediction mode, the intra prediction image generation unit 310 performs intra prediction by using an intra prediction parameter input from the intra prediction parameter decoder 304 and a reference pixel read out from the reference picture memory 306.

Specifically, the intra prediction image generation unit 310 reads, from the reference picture memory 306, neighboring blocks located on a target picture within a prescribed range from a target block. The prescribed range corresponds to left, top left, top, and top right neighboring blocks of the target block, and reference areas vary depending on the intra prediction mode.

The intra prediction image generation unit 310 refers to read decoded pixel values and the prediction mode indicated by IntraPredMode to generate a prediction image of the target block. The intra prediction image generation unit 310 outputs the generated prediction image of the block to the addition unit 312.

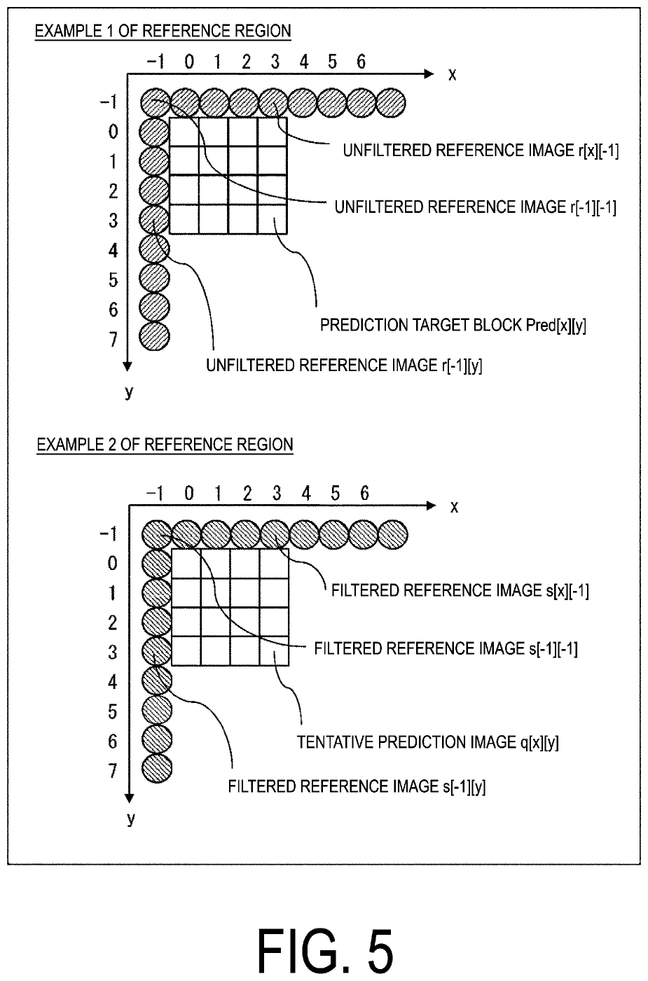

The generation of a prediction image based on the intra prediction mode will be described below. In Planar prediction, DC prediction, and Angular prediction, a decoded peripheral region adjacent to (proximate to) a prediction target block is configured as a reference region R. Then, the pixels on the reference region R are extrapolated in a particular direction to generate the prediction image. For example, the reference region R may be configured as an L-shaped region (e.g., the region indicated as circular pixels with diagonal lines in Example 1 of the reference region in FIG. 5) including the left and upper regions (or further the top left, top right, and bottom left regions) of the prediction target block.

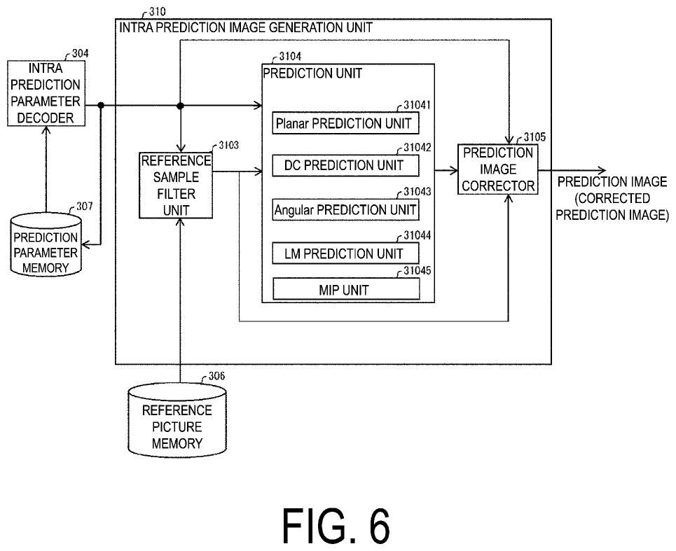

Details of Prediction Image Generation Unit Next, a configuration of the intra prediction image generation unit 310 will be described in detail with reference to FIG. 6. The intra prediction image generation unit 310 includes a reference sample filter unit 3103 (second reference image configuration unit), a prediction unit 3104, and a prediction image corrector 3105 (a prediction image corrector, a filter switching unit, and a weighting factor change unit).

The prediction unit 3104 generates a tentative prediction image (pre-correction prediction image) of the prediction target block and outputs the tentative prediction image to the prediction image corrector 3105 based on each reference pixel (reference image) on the reference region R, the filtered reference image generated by applying the reference pixel filter (first filter), and the intra prediction mode. The prediction image corrector 3105 corrects the tentative prediction image according to the intra prediction mode, generates a prediction image (corrected prediction image), and outputs the prediction image.

Each part included in the intra prediction image generation unit 310 will be described below.

### Reference Sample Filter Unit 3103

The reference sample filter unit 3103 derives a reference sample s[x][y] at each position (x, y) on the reference region R with reference to the reference image. In addition, the reference sample filter unit 3103 applies the reference pixel filter (first filter) to the reference sample s[x][y] according to the intra prediction mode to update the reference sample s[x][y] at each position (x, y) on the reference region R (derives a filtered reference image s[x][y]). Specifically, a low-pass filter is applied to the position (x, y) and the reference image in the vicinity thereof to derive a filtered reference image (Example 2 of the reference region in FIG. 5). Note that it is not always necessary to apply the low-pass filter to all the intra prediction modes, and the low-pass filter may be applied to some of the intra prediction modes. Further, while the filter applied to the reference image on the reference region R by the reference sample filter unit 3103 is referred to as a “reference pixel filter (first filter)”, the filter for correcting the tentative prediction image by the prediction image corrector 3105 described below is referred to as a “position-dependent filter (second filter)”.

### Configuration of Intra Prediction Unit 3104

The intra prediction unit 3104 generates a tentative prediction image (tentative prediction pixel value or pre-corrected prediction image) of the prediction target block based on the intra prediction mode, the reference image, and the filtered reference pixel value, and outputs the tentative prediction image to the prediction image corrector 3105. The prediction unit 3104 includes a planar prediction unit 31041, a DC prediction unit 31042, an angular prediction unit 31043, an LM prediction unit 31044, and an MIP unit 31045 therein. The prediction unit 3104 selects a specific prediction unit according to the intra prediction mode, and inputs the reference image and the filtered reference image. The relationship between the intra prediction mode and the corresponding prediction unit is as follows.
Planar prediction: planar prediction unit 31041
DC prediction: DC prediction unit 31042
Angular prediction: angular prediction unit 31043
LM prediction: LM prediction unit 31044
Matrix intra prediction: MIP unit 31045

### Planar Prediction

The planar prediction unit 31041 generates a tentative prediction image by linearly adding reference samples s[x][y] together in accordance with the distance between a prediction target pixel position and a reference pixel position, and outputs the tentative prediction image to the prediction image corrector 3105.

### DC Prediction

The DC prediction unit 31042 derives a DC prediction value corresponding to the average value of the reference samples s[x][y] and outputs a tentative prediction image q[x][y] having the DC prediction value as a pixel value.

### Angular Prediction

The angular prediction unit 31043 generates a tentative prediction image q[x][y] using the reference samples s[x][y] in the prediction direction (reference direction) indicated by the intra prediction mode, and outputs the tentative prediction image to the prediction image corrector 3105.

### LM Prediction

The LM prediction unit 31044 predicts a chroma pixel value based on a luminance pixel value. Specifically, this is a scheme in which a prediction image of a chroma image (Cb, Cr) is generated by using a linear model based on a decoded luminance image. One of LM predictions is Cross-Component Linear Model (CCLM) prediction. CCLM prediction is a prediction scheme using a linear model for predicting chrominance from luminance for one block.

### Configuration of Prediction Image Corrector 3105

The prediction image corrector 3105 corrects the tentative prediction image output from the prediction unit 3104 according to the intra prediction mode. Specifically, the prediction image corrector 3105 derives a weighting factor depending on a position for each pixel of the tentative prediction image in accordance with the positions of the reference region R and the target prediction pixel. Then, the reference sample s[ ][ ] and the tentative prediction image are subjected to weighted addition (weighted average) to derive a prediction image (corrected prediction image) Pred [ ][ ] obtained by correcting the tentative prediction image. Further, in some intra prediction modes, the prediction image corrector 3105 may not correct the tentative prediction image, and the output of the prediction unit 3104 may be used as a prediction image as it is.

### First MIP Example

The MIP parameter decoder 3041 decodes intra_mip_flag from coded data. In a case that intra_mip_flag is 1, the MIP parameter decoder 3041 decodes intra_mip_transposed_flag and the matrix intra prediction mode indicator intra_mip_mode_idx. intra_mip_mode_idx is a value from 0 to NumMipModes−1, and may be decoded by using a truncated binary (TB) code of cMax=NumMipModes−1. NumMipModes is the number of MIP operations available in a target block. For example, depending on a size of the target block (nTbW, nTnH), cMax may be derived as follows.
cMax=(nTbW==4&& nTbH==4)?NumMipModes_SizeId0-1:(nTbW==4∥nTbH==4)∥(nTbW==8& & nTbH==8)?NumMipModes_SizeId1−1: NumMipModes_SizeId2−1

For example, although NumMipModes_SizeId0=16, NumMipModes_SizeId1=8, and NumMipModes_SizeId2=6, the present invention is not limited thereto.

### Second MIP Example

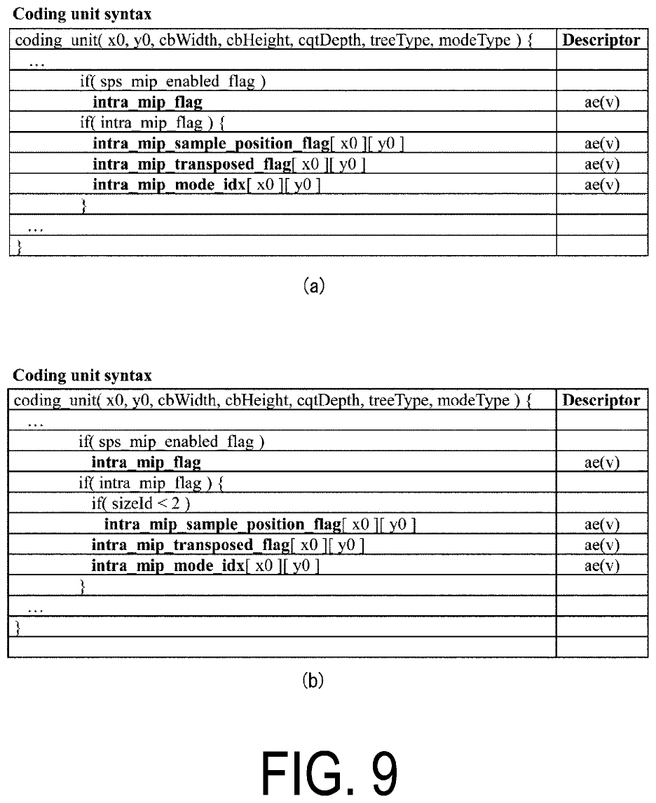

FIG. 9(a) illustrates an example of syntax of coded data related to MIP. When the flag sps_mip_enabled_flag for configuring whether to use MIP in the entire sequence indicates that MIP is available, the MIP parameter decoder 3041 decodes the flag intra_mip_flag that indicates whether to perform MIP prediction in the target block from the coded data. In a case that intra_mip_flag is 1, the MIP parameter decoder 3041 decodes intra_mip_sample_position_flag, intra_mip_transposed_flag, and intra_mip_mode_idx indicating a matrix used for prediction. intra_mip_sample_position_flag indicates a reference region used to derive a pixel value input to MIP prediction, and is a flag for selecting one of a plurality of reference regions. intra_mip_transposed_flag is a flag indicating which of an upper reference pixel and a left reference pixel of the target block is stored first in a reference region p[ ] to be described below. In addition, intra_mip_transposed_flag is also a flag indicating whether to transpose an intermediate prediction image. intra_mip_mode_idx is a value from 0 to NumMipModes−1, and may be decoded by the MIP parameter decoder 3041 using a Truncated Binary (TB) code of cMax=NumMipModes−1. NumMipModes is the number of MIP operations available in a target block. The MIP parameter decoder 3041 may derive cMax as follows, depending on a variable sizeId related to the size of the target block (nTbW, nTnH), for example.
sizeId=(nTbW==4 && nTbH==4)? 0:(nTbW==4∥nTbH==4)∥(nTbW==8 &&
nTbH==8)?1:2 (MIP-1)
cMax=(sizeId==0)? NumMipModes_SizeId0−1:(sizeId==1)?

### NumMipModes_SizeId1−1: NumMipModes_SizeId2−1

For example, although NumMipModes_SizeId0=16, NumMipModes_SizeId1=8, and NumMipModes_SizeId2=6, the present invention is not limited thereto.

FIG. 9(b) illustrates another example of syntax. The MIP parameter decoder 3041 may determine whether to decode intra_mip_sample_position_flag in accordance with the size of the target block (e.g., sizeId) as illustrated in the drawing. In this example, in a case that the size of the target block is small (e.g., sizeId<2), intra_mip_sample_position_flag is decoded, and in other cases (sizeId>=2), intra_mip_sample_position_flag is not decoded and is implicitly configured to 0. Although the conditional expression is sizeId<2 in the example of FIG. 9(b), the invention is not limited to this. For example, the MIP parameter decoder 3041 may decode intra_mip_sample_position_flag only in a case that sizeId is a specific value (e.g., 1), and intra_mip_sample_position_flag may be configured to have 0 in other cases.

Further, the order of intra_mip_sample_position_flag, intra_mip_transposed_flag, and intra_mip_mode_idx is not limited to that in the example of FIG. 9, and syntax having a different order may be used.

Further, in the above example, the syntax element for deriving a mode number modeId indicating a matrix of MIP prediction and the syntax element for selecting the reference region are different syntax elements. As another example, the MIP parameter decoder 3041 may decode one syntax element intra_mip_mode_idx to derive a flag for selecting the reference region and modeId. For example, the MIP parameter decoder 3041 may derive intra_mip_sample_position_flag from information (e.g., the least significant bit) of a specific position of intra_mip_mode_idx.
intra_mip_sample_position_flag=intra_mip_mode_idx & 1
modeId=intra_mip_mode_idx>>1

In this case, a mode number similar to that of the related art is stored on the upper bit side of intra_mip_mode_idx. Therefore, the MIP parameter decoder 3041 can obtain intra_mip_mode_idx of the related art by shifting intra_mip_mode_idx to the right by one bit after extracting the least significant bit. Further, it should be noted that intra_mip_sample_position_flag may be derived in other operations such as one with a remainder of 2 as long as it is a process of extracting the least significant bit. In addition, the above derivation may be switched according to a specific size (e.g., the value of sizeId). For example, an example of applying the above only when sizeId is less than 2 is as follows.

```
if (sizeId < 2) {
  intra_mip_sample_position_flag = intra_mip_mode_idx & 1
  modeId = intra_mip_mode_idx >> 1
} else {
  intra_mip_sample_position_flag = 0
  modeId = intra_mip_mode_idx
}
```

A table may be used as a method for deriving modeId and intra_mip_sample_position_flag from the syntax value intra_mip_mode_idx. For example, the MIP parameter decoder 3041 uses MipRefPosTbl[ ][ ] and MipModeTbl[ ][ ], refers to these tables by using sizeId and intra_mip_mode_idx, and derives intra_mip_sample_position_flag and intra_mip_mode_idx. MipRefPosTbl[ ][ ] is a table in which intra_mip_mode_idx is associated with intra_mip_sample_position_flag. MipModeTbl[ ][ ] is a table in which intra_mip_mode_idx is associated with modeId.
intra_mip_sample_position_flag=MipRefPosTbl[sizeId][intra_mip_mode_idx]
modeId=MipModeTbl[sizeId][intra_mip_mode_idx]

### Example of TB Code

TB codes may be derived as follows.

$$n = c Max + 1$$

$$k = Floor ( Log 2 ( n ) )$$

$$u = ( 1 << ( k + 1 ) ) - n$$

In a case that the value syn Val (merge_gpm_partition_idx in this case) of a syntax element is less than u, the parameter decoder 302 derives TB codes by using Fixed Length Binary (hereinafter referred to as FL binary) using cMax=(1<<k)−1. In other cases, (syn Val is greater than or equal to u), cMax=(1<<(k+1))−1 is configured.

Further, to derive the FL binary, the parameter decoder 302 may derive a BIN length fixedLength of the syntax element, and may derive the BIN length by expressing syn Val with binary numbers using fixedLength bits.

$$fixedLength = Ceil ( Log 2 ( + 1 ) )$$

In addition, the parameter decoder 302 may binarize mpm_merge_gpm_partition_idx using a Truncated Rice (TR) code in which cMax is determined and a rice parameter is configured to 0. In an example in which mpm_merge_gpm_partition_idx takes a value from 0 to 5 and one candidate is selected from six candidates, the value of mpm_merge_gpm_partition_idx is coded as a bit string having a maximum of 5 bits (binary values: 0, 10, 110, 1110, 11110, 11111).

An example of MIP processing (Matrix-based intra prediction) executed by the MIP unit 31045 will be described below. MIP is a technique for deriving a prediction image in a product-sum operation of a reference image derived from an adjacent image and a weight matrix.

### Configuration and Processing 1 of MIP Unit

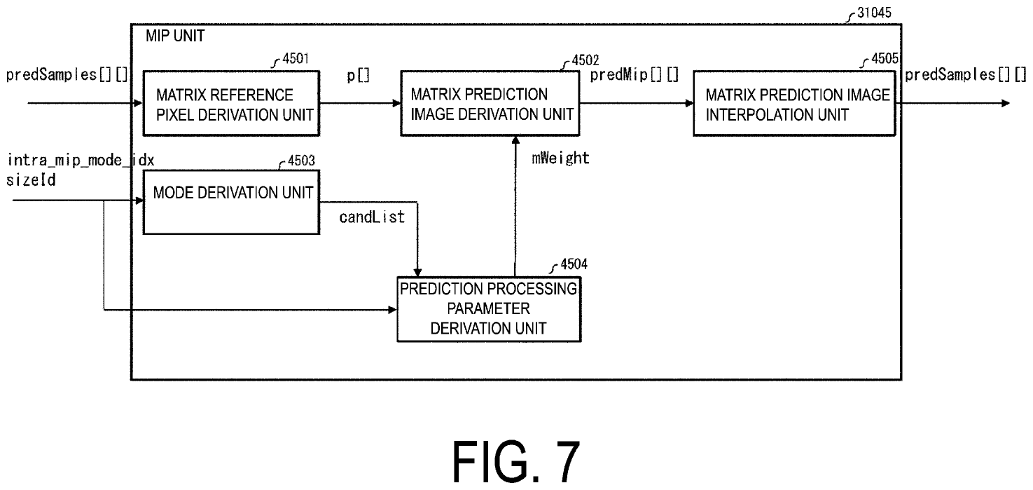

FIG. 7 illustrates a configuration of the MIP unit 31045 in the present embodiment. The MIP unit 31045 includes a matrix reference pixel derivation unit 4501, a matrix prediction image derivation unit 4502, a mode derivation unit 4503, a prediction processing parameter derivation unit 4504, and a matrix prediction image interpolation unit 4505.

### (1) Boundary Reference Pixel Derivation

The MIP unit 31045 derives a variable sizeId related to a size of a target block by using the following expression.

sizeId=(nTbW==4&& nTbH==4)?0:(nTbW==4|nTbH==4)|(nTbW==8&& nTbH==8)?1:2 (MIP-1)

Next, by using sizeId, the MIP unit 31045 derives the total number num TotalMipModes of MIP modes, the size boundary Size of downsampled reference regions redT[ ] and redL[ ], and the width and height predSizeW and predSizeH of an intermediate prediction image predMip[ ][ ]. In the following, a case that the widths and heights of intermediate prediction images are the same, that is, a case of predSize=predSizzeW=predSizeH, will be described.

num TotalMipModes=(sizeId==0)?32:(sizeId==1)?16:12 (MIP-2)
boundary Size=(sizeId==0)?2:4
predSize=(sized<=1)?4:8

In addition, the number of reference pixels used for prediction based on a weight matrix mWeight is derived by using the following expression.

inSize=2*boundarySize−((sizeId==2)?1:0)

The weight matrix mWeight is a matrix having a size represented by m Weight [predSize*predSize][inSize]. In a case of sizeId=0 and sizeId=1, predSize*predSize=16 and inSize=4, and in a case of sizeId=2, predSize*predSize=64 and inSize=7.

The matrix reference pixel derivation unit 4501 sets the pixel values predSamples[x][−1](x=0, . . . , nTbW-1) of the neighboring block at the upper side of the target block to the first reference region refT[x](x=0, . . . , nTbW−1). In addition, the pixel values predSamples[−1][y](y=0, . . . , nTbH−1) of the neighboring block at the left side of the target block are set in the first reference region refL[y](y=0, . . . , nTbH−1). Next, the matrix reference pixel derivation unit 4501 derives second reference regions redT[x](x=0, . . . , boundarySize−1) and redL[y](y=0, . . . , boundary Size−1) by downsampling the first reference regions refT[x] and refL[y]. Since downsampling is performed on refT[ ] and refL[ ] in the same manner, they are hereinafter referred to as refS[i](i=0, . . . , nTbX−1) and redS[i](i=0, . . . , boundarySize−1).

The matrix reference pixel derivation unit 4501 derives redT (=redS[ ]) by performing the following MIP boundary downsampling processing with refT[ ] as refS[ ] and nTbs=bTbH.

The matrix reference pixel derivation unit 4501 derives redL (=redS[ ]) by performing the following MIP boundary downsampling processing with refL[ ] as refS[ ] and nTbs=bTbW.

### MIP Boundary Downsampling Processing

if (boundarySize < nTbS) {

| | |
|---|---|
| bDwn = nTbS/boundarySize | (MIP-3) |

```
    for (x = 0; x < boundarySize; x++)
      redS[x] = (Σ refS [x * bDwn + i] + (1 << Log2(bDwn) − 1))) >>
Log2(bDwn)
  }
  else
    for (x = 0; x < boundarySize; x++)
      redS[x] = refS[x]
  Here, Σ is the total sum from i = 0 to i = bDwn − 1.
```

Next, the matrix reference pixel derivation unit 4501 combines the second reference regions redL[ ] and redT[ ] to derive p[i](i=0, . . . , 2*boundarySize−1). isTransposed configures the value of intra_mip_transposed_flag in the target block.

| | |
|---|---|
| if (isTransposed == 1) | (MIP-4) |

```
  for (i = 0; i < boundarySize; i++) {
    pTemp[i] = redL[i]
    pTemp[i + boundarySize] = redT[i]
}
else
  for (i = 0; i < boundarySize; i++) {
    pTemp[i] = redT[i]
    pTemp[i + boundarySize] = redL[i]
}
if (sizeId == 2)
  for (i = 0; i < inSize; i++)
    p[i] = pTemp[i + 1] − pTemp[0]
else {
  p[0] = pTemp[0] − (1 << (BitDepthY − 1))
  for (i = 1; i < inSize; i++)
    p[i] = pTemp[i] − pTemp[0]
}
```

bitDepthY is the bit depth of luminance and may be, for example, 10 bits.

Further, in a case that the reference pixel cannot be referred to, the value of an available reference pixel is used as in intra prediction of the related art. In a case that all the reference pixels cannot be referred to, 1<< (bitDepthY−1) is used as a pixel value. Since isTransposed indicates whether the prediction direction is close to vertical prediction, the pattern of m Weight [ ][ ] can be reduced to half by switching between redL and redT to be stored in the first half of p[ ] depending on isTransposed.

### (2) Prediction Mode Derivation 4503

The MIP unit 31045 derives an intra prediction mode modeId used in matrix intra prediction (MIP) using the mode derivation unit 4503.

The mode derivation unit 4503 of the MIP unit 31045 derives a candidate list of MIP mode prediction methods used in the target block by using the information of neighboring blocks of the target block. For example, the mode derivation unit 4503 may derive a number mip_set_id indicating the candidate list. Here, if the number of candidate lists is NumMipSet, mip_set_id=0, . . . , NumMipSet−1 is satisfied. If the number of prediction modes in the candidate list is NumMipModes, in a case that different candidate lists do not contain the same prediction mode, the total number of MIP prediction modes Num TotalMipModes at a certain sizeId is NumMipSet*NumMipModes. Further, different candidate lists may include the same prediction mode.

Here, all lists included in MIP are referred to as an entire MIP list. It can be said that the mode derivation unit 4503 derives a subset of the entire MIP list as the candidate list of target blocks.

Derivation Example of mip_set_id

Processing of deriving mip_set_id by the mode derivation unit 4503 will be exemplified. The mode derivation unit 4503 derives the value of mip_set_id based on whether the conditions based on the following are satisfied, for example.
a) The magnitude of a specific element of p[ ] or the magnitude relationship between elements
b) The activity level of a neighboring pixel region derived from p[ ]
c) A feature value such as an average value derived from the elements of p[ ]
d) The absolute value of the difference between adjacent pixel values of p[ ]
e) A quantization parameter QP of the target block

The conditions may be exemplified by using the following expressions.

$$\begin{matrix}a ) & \\ p [ 0 ] < p [ 3 ] , & \end{matrix}$$

$$\begin{matrix}b ) & \\ p [ 0 ] + p [ 1 ] < p [ 2 ] + p [ 3 ] & \end{matrix}$$

$$\begin{matrix}c ) & \\ ( p [ 0 ] + … + p [ inSize - 1 ] ) >> log 2 ( insize ) >= th\_avg , & \end{matrix}$$

$$\begin{matrix}d ) & \\ abs ( p [ 1 ] - p [ 0 ] ) + … + abs ( p [ inSize - 1 ] - p [ inSize - 2 ] ) < th\_sad & \end{matrix}$$

$$\begin{matrix}e ) & \\ QP < th\_qp & \end{matrix}$$

Here, th_avg, th_sad, and th_qp are predetermined constants. Alternatively, values may be derived from a table without using branching.

$$\begin{matrix}a ) & \\ mip\_set \_id = tbl\_grad [ p [ 0 ] - p [ 3 ] ) ] & \end{matrix}$$

$$\begin{matrix}b ) & \\ mip\_set \_id = tbl\_act \_ [ ( p [ 0 ] + p [ 1 ] ) - ( p [ 2 ] + p [ 3 ] ) ] & \end{matrix}$$

$$\begin{matrix}c ) & \\ mip\_set \_id = tbl\_avg [ ( p [ 0 ] + … + p [ inSize - 1 ] ) >> log2 ( insize ) ] & \end{matrix}$$

$$\begin{matrix}d ) & \\ mip\_set \_id = tbl\_sad [ abs ( p [ 1 ] - p [ 0 ] ) + … + abs ( p [ inSize - 1 ] - p [ inSize - 2 ] ) ] & \end{matrix}$$

$$\begin{matrix}e ) & \\ mip\_set \_id = tbl\_qp [ Q P ] & \end{matrix}$$

Here, tbl_avg, th_act, tbl_avg, tbl_sad, and tbl_qp are tables.

### Derivation Example 1 of MIP Prediction Method

The MIP unit 31045 may be configured such that the mode derivation unit 4503 derives mip_set_id from the surroundings and the prediction processing parameter derivation unit 4504 derives mWeight from modeId obtained from intra_mip_mode_idx of the coded data and sizeId. The modeId is derived by using intra_mip_mode_idx decoded from the coded data.
modeId=intra_mip_mode_idx

The MIP unit 31045 derives m Weight from mip_set_id, modeId (intra_mip_mode_idx), and sizeId.

For example, the MIP unit 31045 may derive a matrix from mip_set_id, modeId, and sizeId with reference to a table as follows.
m Weight=mWeightTable [sizeId][mip_set_id][modeId]

Alternatively, a specific table may be selected by the following branching.

```
if (sizeId == 0 && mip_set_id == 0 && modeId == 0)
  mWeight = mWeightTable[0][0][0]
else if (sizeId == 0 && mip_set_id == 0 && modeId == 1)
  mWeight = mWeightTable[0][0][1]
else if (sizeId == 0 && mip_set_id == 1 && modeId == 0)
  mWeight = mWeightTable[0][1][0]
else if (sizeId == 0 && mip_set_id == 1 && modeId == 1)
  mWeight = mWeightTable[0][1][1]
else if (sizeId == 1 && mip_set_id == 0 && modeId == 0)
  mWeight = mWeightTable[1][0][0]
else if (sizeId == 1 && mip_set_id == 0 && modeId == 1)
  mWeight = mWeightTable[1][0][1]
...
else if (sizeId == 2 && mip_set_id == NumMipSet − 1 &&
modeId == 0)
  mWeight = mWeightTable[2][NumMipSet − 1][0]
else if (sizeId == 2 && mip_set_id == NumMipSet − 1 &&
modeId == 1)
  mWeight = mWeightTable[2][NumMipSet − 1][1]
```

### Derivation Example 2 of MIP Prediction Method

The mode derivation unit 4503 may be configured to derive a candidate list indicated by mip_set_id and derive a prediction mode from the candidate list and intra_mip_mode_idx. Candidate lists (subset) of MIP selected by the mode derivation unit 4503 may be as follows.
List of prediction mode numbers of MIP (configuration 1)
List of matrices used for MIP (configuration 2)
List of neural network parameters used for MIP (configuration 3)

### Specific Example of Configuration 1

The mode derivation unit 4503 derives a candidate list modeIdCandListSet of modeId selectable from sizeId, mip_set_id, and a set modeIdCandListSet of candidate lists of modeId of MIP.
modeIdCandList=modeIdCandListSet[mip_set_id]

Here, modeIdCandList[ ] is a list having modeId as an element.

For example, the following may be included.
modeIdCandListSet[0][ ]={0, 1, 2, 3}
modeIdCandListSet[1][ ]={0, 1, 4, 5}
modeIdCandListSet[2][ ]={0, 1, 6, 7}

In this example, if mip_set_id=0, modeIdCandList[ ]={0, 1, 2, 3}.

The mode derivation unit 4503 derives modeId from modeIdCandList and intra_mip_mode_idx.
modeId=modeIdCandList[intra_mip_mode_idx]

In addition, modeIdCandListSet may be a set of other candidate lists for sizeId as described below.
modeIdCandList=modeIdCandListSet[sizeId][mip_set_id]
modeIdCandListSet[sizeId][0][ ]={0, 1, 2, 3}
modeIdCandListSet[sizeId][1][ ]={0, 1, 4, 5}
modeIdCandListSet[sizeId][2][ ]={0, 1, 6, 7}

That is, modeId=modeIdCandListSet[sizeId][mip_set_id][intra_mip_mode_idx].

The prediction processing parameter derivation unit 4504 selects a weight matrix mWeight[predSize*predSize][inSize] from a set of matrices with reference to sizeId and modeId.

In a case of sizeId=0, the prediction processing parameter derivation unit 4504 selects mWeight[16][4] from an array WeightS0[16][16][4] storing the weight matrix with reference to modeId. In a case of sizeId=1, mWeight[16][8] is selected from the array WeightS1 [8][16][8] storing the weight matrix by referring to modeId. In a case of sizeId=2, m Weight [64][7] is selected from the array WeightS2 [6][64][7] storing the weight matrix by referring to modeId. These are expressed by the following expressions.

if(sizeId==0) (MIP-5)
mWeight[i][j]=WeightS0[modeId][i][j] (i=0, . . . , 15, j=0, . . . , 3)
else if (sizeId==1)
mWeight[i][j]=WeightS1 [modeId][i][j] (i=0, . . . , 15, j=0, . . . , 7)
else//sizeId=2
mWeight[i][j]=WeightS2 [modeId][i][j] (i=0, . . . , 63, j=0, . . . , 6)

### Specific Example of Configuration 2

The mode derivation unit 4503 of the MIP unit 31045 derives a candidate list matrixCandList of selectable matrices from sizeId, mip_set_id, and the entire candidate list matrixCandListSet of selectable MIP matrices as follows.
matrixCandList=matrixCandListSet[sizeId][mip_set_id]

Here, matrixCandList[ ] is a list having the weight matrix mWeightX corresponding to one prediction mode as elements. mWeightX is a matrix of sizes (predSize*predSize, inSize).

For example, the following may be included.
matrixCandListSet[sizeId][0][ ]={mWeight0, mWeight1, mWeight2, mWeight3}
matrixCandListSet[sizeId][1][ ]={mWeight0, mWeight1, mWeight4, mWeight5}
matrixCandListSet[sizeId][2][ ]={mWeight0, mWeight1, mWeight6, mWeight7}

The prediction processing parameter derivation unit 4504 of the MIP unit 31045 derives mWeight from matrixCandList and intra_mip_mode_idx.
mWeight=matrixCandList[intra_mip_mode_idx]

The entire expression is as follows.
mWeight=matrixCandListSet[sizeId][mip_set_id][intra_mip_mode_idx]

Further, (Derivation Example 1 of MIP Prediction Method) described above formally performs the same operation as follows.
mWeight=mWeightTable [sizeId][mip_set_id][intra_mip_mode_idx]

### Specific Example of Configuration 3

The mode derivation unit 4503 of the MIP unit 31045 derives the candidate list modelCandList of the selectable neural network model from mip_set_id and the entire candidate list modelCandListSet of the selectable MIP neural network model as follows.
modelCandList=modelCandListSet[sizeId][mip_set_id]

Here, modelCandList[ ] is a list including a neural network NNX corresponding to one prediction mode as an element. The NNX is a parameter indicating a neural network model to which input data p[ ] of a length inSize is input and which outputs an intermediate prediction image of (predSize*predSize).

For example, the following may be included.
modelCandListSet[0][ ]={NN0, NN1, NN2, NN3}
modelCandListSet[1][ ]={NN0, NN1, NN4, NN5}
modelCandListSet[2][ ]={NN0, NN1, NN6, NN7}

The prediction processing parameter derivation unit 4504 of the MIP unit 31045 derives a neural network NN used for prediction from modelCandList and intra_mip_mode_idx.
NN=modelCandList[intra_mip_mode_idx]

The neural network NN is represented by a network structure and parameters (values of weights and biases). Alternatively, an index or a parameter for indirectly specifying such information may be used. For example, a neural network in which input layers in the number of inSize and outputs layers in the number of predSize*predSize are fully concatenated has weight parameters in the number of inSize*predSize*predSize.

In this way, by specifying a mode to be used from a candidate list smaller in number than the total number of modes, it is possible to reduce the data amount of syntax necessary for selection and improve coding efficiency. For example, a case that the total number of modes of MIP at a certain sizeId is 2L and a candidate list including L elements (modes) is derived for a target block is considered. In this case, the matrix intra prediction mode indicator intra_mip_mode_idx can specify a mode with a data amount smaller by one bit than in the case that one mode is selected from all the modes of matrix intra prediction. In other words, by setting the size of one candidate list to a number equal to or less than half the total number of modes, it is possible to select a prediction mode with a small data amount. Candidate modes may be determined such that each prediction mode belongs to any one of the candidate modes. As another example, if a candidate list with L elements is derived when the total number of modes is 4L, the mode can be specified with a data amount that is less by two bits.

### Another Specific Example of Candidate List Derivation

The mode derivation unit 4503 of the MIP unit 31045 may derive a candidate list of prediction modes for a target block based on p[ ] or another value each time. For example, the derivation is processed as follows.

A candidate list candList is initialized. Although the initial state is empty in the following example, one or more elements may be included. As described above, an element of candList may be the intra prediction mode modeId, the weight matrix mWeight, or the neural network NN. If a predetermined condition is satisfied, the MIP unit 31045 adds an element to the candList.

Specific examples of the conditions used here include an evaluation formula based on the following.
a) The magnitude of a specific element of p[ ] or the magnitude relationship between elements
b) A feature value such as an average value derived from elements of p[ ]
c) The absolute value of the difference between adjacent pixel values of p[ ]
d) The activity level of a neighboring pixel region derived from p[ ]
e) A quantization parameter QP of the target block

For example, they can be expressed by the following expressions.

$$\begin{matrix}a ) & \\ p [ 0 ] < p [ 3 ] , & \end{matrix}$$

$$\begin{matrix}b ) & \\ p [ 0 ] + p [ 1 ] < p [ 2 ] + p [ 3 ] & \end{matrix}$$

$$\begin{matrix}c ) & \\ ( p [ 0 ] + … + p [ inSize - 1 ] ) >> log 2 ( insize ) >= th\_avg , & \end{matrix}$$

$$\begin{matrix}d ) & \\ abs ( p [ 1 ] - p [ 0 ] ) + … + abs ( p [ inSize - 1 ] - p [ inSize - 2 ] ) < th\_sad & \end{matrix}$$

$$\begin{matrix}e ) & \\ QP < th\_qp & \end{matrix}$$

Alternatively, information other than p[ ] may be used to evaluate the conditions. For example, they are as follows.
a) Whether a quantization parameter (QP) of a target block or a neighboring block satisfies a predetermined range or magnitude relationship
b) Whether a size of a neighboring block, an intra prediction mode of the neighboring block is a specific type (planar prediction, angular prediction, matrix intra prediction, or the like)
c) Whether a mode is equivalent to a magnitude relationship in terms of mode number of a specific mode

Alternatively, a composite condition obtained by a logical operation of these conditions may be used.

In this way, the mode derivation unit 4503 of the MIP unit 31045 derives the final candidate list candList based on cond[sizeId][X] and addList[sizeId][X]. If candList is a list of mode IDs derived from the above-described configuration example 1, the MIP unit 31045 derives a mode modeId used for prediction from the candidate list candList and intra_mip_mode_idx.
modeId=candList[intra_mip_mode_idx]

The method in which the prediction processing parameter derivation unit 4504 derives mWeight from the expression is as described in the specific example of the configuration 1.

If candList is a list of weight matrices derived in the configuration example 2, the prediction processing parameter derivation unit 4504 derives mWeight using candList and intra_mip_mode_idx as follows.
mWeight=candList[intra_mip_mode_idx]

If candList is a list of neural networks derived in the configuration example 3, the prediction processing parameter derivation unit 4504 derives NN using candList and intra_mip_mode_idx as follows.
NN=candList[intra_mip_mode_idx]

### (3) Prediction Pixel Derivation (Matrix Operation)

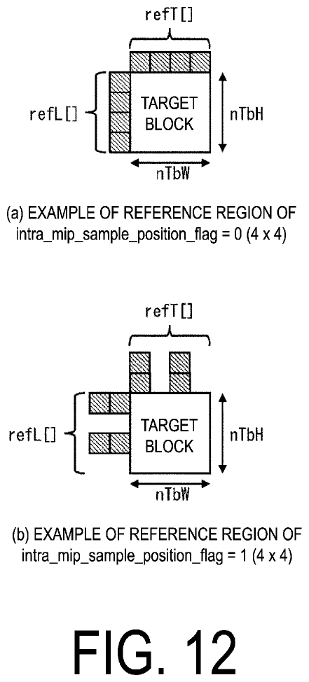

The MIP unit 31045 derives an intermediate prediction image predMip[ ][ ] having a size of predSizeW*predSizeH by performing a matrix operation on p[ ] in STEP3 prediction pixel derivation (matrix operation) of FIG. 12. predSizeW=predSizeH (=predSize) may be established. First, an example in which the weight matrix mWeight[ ][ ] derived in the configuration example 1 and the configuration example 2 is used to derive the intermediate prediction image predMip[ ][ ] will be described.

The matrix prediction image derivation unit 4502 of the MIP unit 31045 derives predMip[ ][ ] in the size of predSizeW*predSizeH by performing a matrix operation of (MIP-7) on p[ ]. Here, the elements of the weight matrix mWeight[ ][ ] are referred to for each corresponding position of predMip[ ][ ] to derive an intermediate prediction image.

| oW = 32 − 32 * Σ {i = 0,... inSize − 1} p[i] | |
|---|---|
| for (x = 0; x < predSizeW; x++) | (MIP-7) |

```
    for (y = 0; y < predSizeH; y++) {
      predMip[x][y] = (((Σ {i = 0,... inSize − 1}
      (mWeight[i][y * predSizeW + x]
* p[i]) + oW) >> 6) + pTemp [0]
      predMip[x][y] = Clip1Y(predMip[x][y])
    }
```

Here, {i=a, . . . , b} is the sum from i=a to i=b.

In a case that isTransposed=1, the matrix prediction image derivation unit 4502 replaces the positions of the upper reference pixel and the left reference pixel with each other and stores them in the input p[ ] to a product-sum operation. For example, the following processing is performed.

| | |
|---|---|
| if (isTransposed == 1) { | (MIP-8) |

```
  for (x = 0; x < predSizeW; x++)
    for (y = 0; y < predSizeH; y++)
      tmpPred[x][y] = predMip[y][x]
  for (x = 0; x < predSizeW; x++)
    for (y = 0; y < predSizeH; y++)
      predMip[x][y]= tmpPred[x][y]
}
```

In the derivation processing of the intermediate prediction image predMip[ ][ ], the matrix prediction image derivation unit 4502 can use the neural network NN derived in the configuration example 3 instead of the two-dimensional weight matrix mWeight[ ][ ]. The neural network NN is a model (network structure) in which an input layer receives one-dimensional data of the number of elements inSize and an output layer outputs two-dimensional data of predSizeW×predSizeH. When a function func_NN and input data p[ ] are input for conversion by this network, a prediction image predMip of predSizeW×predSizeH is expressed by the following expression.

predMip=func_NN(p) (MIP-9)

Here, processing of transposing the output in the case of isTransposed=1 is as described above in (MIP-8).

In addition, the neural network NN may receive input of parameters other than p[ ] derived from the adjacent pixel value. The parameters are, for example, the prediction modes IntraPredModeT and IntraPredModeL of the upper and left neighboring blocks, the QP values of the target block or the neighboring block, and the like. Based on these additional parameters in addition to p[ ], it is possible to derive a prediction image in which coding information near the target block is taken into consideration.

Further, the number and structure of intermediate layers (hidden layers) of the neural network NN may be arbitrarily configured. However, since the amount of calculation increases according to the complexity of the network, a simple configuration with one or two layers or the like is desirable. In addition, it is not preferable that the amount of calculation of the network greatly varies depending on the models. For this reason, for prediction modes belonging to the same sizeId, it is desirable to keep the calculation amount constant by, for example, changing parameters while keeping the model the same.

Thus, the matrix prediction image derivation unit 4502 transposes the output predMip[ ][ ] of the product-sum operation before outputting the output to the processing in (4).

### (4) Prediction Pixel Derivation (Linear Interpolation)

In a case that nTbW=predSizeW and nTbH=predSizeH, the matrix prediction image interpolation unit 4505 of the MIP unit 31045 copies predMip[ ][ ] to predsamples[ ][ ].
for (x=0; x<nTbW; x++)
   for (y=0; y<nTbH; y++)
      predSamples[x][y]=predMip[x][y]

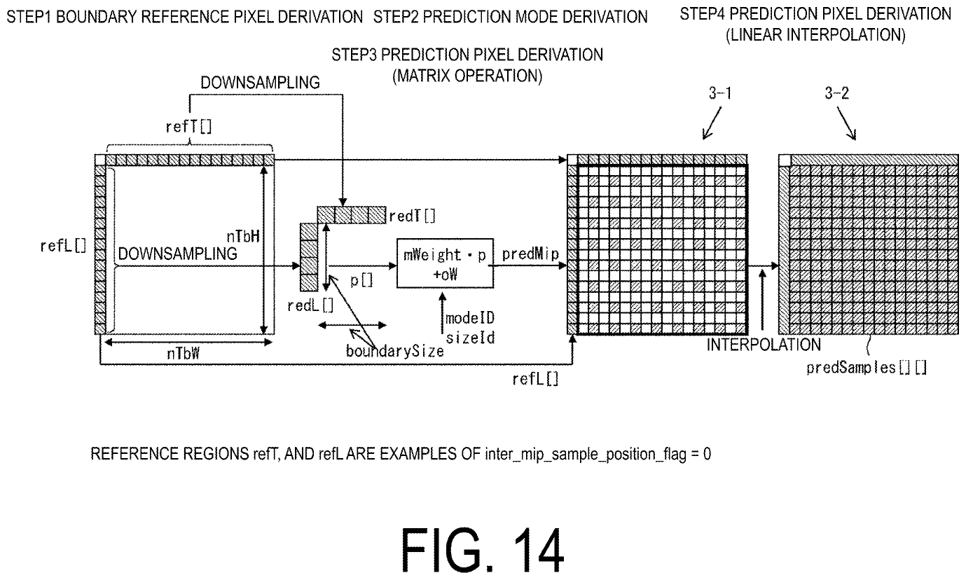

In addition, in a case of (nTbW>predSizeW or nTbH>predSizeH), the matrix prediction image interpolation unit 4505 stores predMip[ ][ ] in the prediction image predSamples[ ][ ] in the size of nTbW*nTbH in 4-1 of STEP4 prediction pixel derivation (linear interpolation) in FIG. 14. In a case that predSizeW and nTbW are different or predSizeH and nTbH are different, prediction pixel values are interpolated in 4-2.

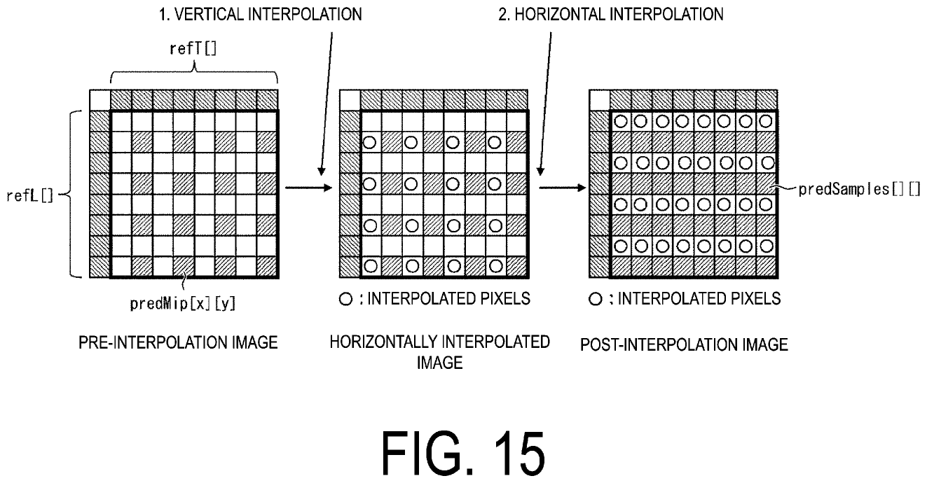

(4-1) The matrix prediction image interpolation unit 4505 stores predMip[ ][ ] in predSamples[ ][ ]. That is, in the pre-interpolation image of FIG. 15, predMip[ ][ ] is stored at the shaded pixel position in the top right and bottom left direction.

upHor=nTbW/predSizeW

up Ver=nTbH/predSizeH (MIP-10)
for (x=0; x<predSizeW; x++)
   for (y=0; y<predSizeH; y++)
      predSamples[(x+1)*upHor−1][(y+1)*upVer−1]=predMip[x][y]

(4-2) In a case of nTbH>nTbW, the matrix prediction image interpolation unit 4505 interpolates the pixels not stored in (4-1) using the pixel values of the neighboring blocks horizontally and vertically in this order to generate a prediction image.

In a case that nTbH and predSizeW are different from each other, the matrix prediction image interpolation unit 4505 performs horizontal-direction interpolation and derives a pixel value at a position indicated by “o” using predSamples[xHor][yHor] and predSamples[xHor+upHor][yHor] (shaded pixels of the horizontal-interpolated image in the drawing).

| | |
|---|---|
| for (m = 0; m < predSizeW; m++) | (MIP-11) |

```
    for (n = 1; n <= predSizeH; n++)
      for (dX = 1; dX < upHor; dX++) {
        xHor = m * upHor − 1
        yHor = n * upVer − 1
        sum = (upHor − dX) * predSamples[xHor][yHor] + dX *
predSamples[xHor + upHor][yHor]
        predSamples[xHor + dX][yHor] = (sum + upHor/2)/upHor
      }
```

In a case that nTbH and predSizeH are different from each other, the matrix prediction image interpolation unit 4505 derives a pixel value at a position indicated by “∘” using predSamples[xVer][y Ver] and predSamples[xVer][yVer+upVer] (shaded pixels of the vertically interpolated image in the drawing) after the horizontal-direction interpolation.

| | |
|---|---|
| for (m = 0; m < nTbW; m++) | (MIP-12) |

```
    for (n = 0; n < predSizeH; n++)
      for (dY = 1; dY < upVer; dY++) {
        xVer = m
        yVer = n * upVer − 1
        sum = (upVer − dY) * predSamples[xVer][yVer] +
dY*predSamples[xVer][yVer + upVer]
        predSamples[xVer][yVer + dY] = (sum + upVer/2)/upVer
    }
```

In a case of nTbH<=nTbW, the matrix prediction image interpolation unit 4505 performs interpolation using the pixel values of the neighboring blocks in order of the vertical direction and the horizontal direction to generate a prediction image. The vertical and horizontal interpolation processing is the same as that in the case of nTbH>nTbW.

The inverse quantization and inverse transform processing unit 311 performs inverse quantization on a quantized transform coefficient input from the entropy decoder 301 to calculate a transform coefficient. The quantized transform coefficient is a coefficient obtained by performing, in coding processing, a frequency transform such as a Discrete Cosine Transform (DCT) or a Discrete Sine Transform (DST) on prediction errors for quantization. The inverse quantization and inverse transform processing unit 311 performs an inverse frequency transform such as an inverse DCT or an inverse DST on the obtained transform coefficient to calculate a prediction error. The inverse quantization and inverse transform processing unit 311 outputs the prediction error to the addition unit 312.

The addition unit 312 adds the prediction image of the block input from the prediction image generation unit 308 and the prediction error input from the inverse quantization and inverse transform processing unit 311 for each pixel, and generates a decoded image of the block. The addition unit 312 stores the decoded image of the block in the reference picture memory 306, and also outputs the decoded image to the loop filter 305.

In the above-described configuration, the prediction image is generated by switching two or more different reference regions, and thus it is possible to generate a prediction image more suitable for the original image. A transform matrix may be switched using the syntax of the coded data or may be switched according to the reference region. For example, both the reference region and the transform matrix may be switched according to a flag in the coded data.

### Configuration and Processing 2 of MIP Unit

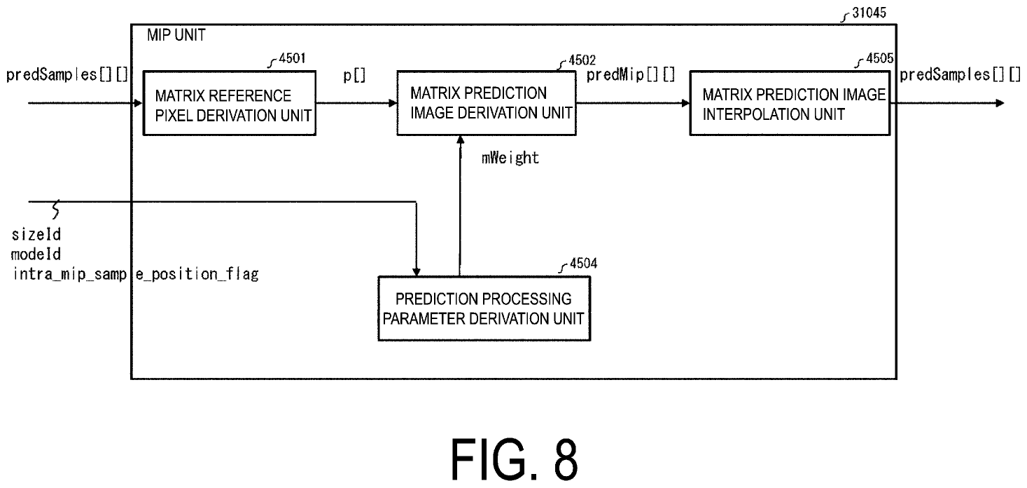

Next, another example of the configuration and processing of the MIP unit 31045 will be described. FIG. 8 illustrates a configuration of the MIP unit 31045 in the present embodiment. The MIP unit 31045 includes the matrix reference pixel derivation unit 4501, the matrix prediction image derivation unit 4502, the prediction processing parameter derivation unit 4504, and the matrix prediction image interpolation unit 4505.

### (1) Boundary Reference Pixel Derivation

Next, by using sizeId, the MIP unit 31045 of the present example, derives the total number num TotalMipModes of MIP modes, the downsampled reference region redT[ ], the size boundary Size of redL[ ], and the width and height predSizeW and predSizeH of the intermediate prediction image predMip[ ][ ]. Further, in the present example, the intermediate prediction image has a square shape, that is, the intermediate prediction image having the same width predSizeW and height predSizeH, and predSizeW=predSizeH=predSize is satisfied. However, the shape of the intermediate prediction image is not limited to this.

num TotalMipModes=(sizeId==0)?32:(sizeId==1)?16:12 (MIP-2)
boundary Size=(sizeId==0)? 2:4
predSize=(sizeId<=1)? 4:8

In addition, the MIP unit 31045 derives the number of reference pixels inSize to be used for prediction using the weight matrix mWeight by the following expression.

inSize=2*boundarySize−((sizeId==2)?1:0)

The following may also be used.

inSize=2*boundarySize

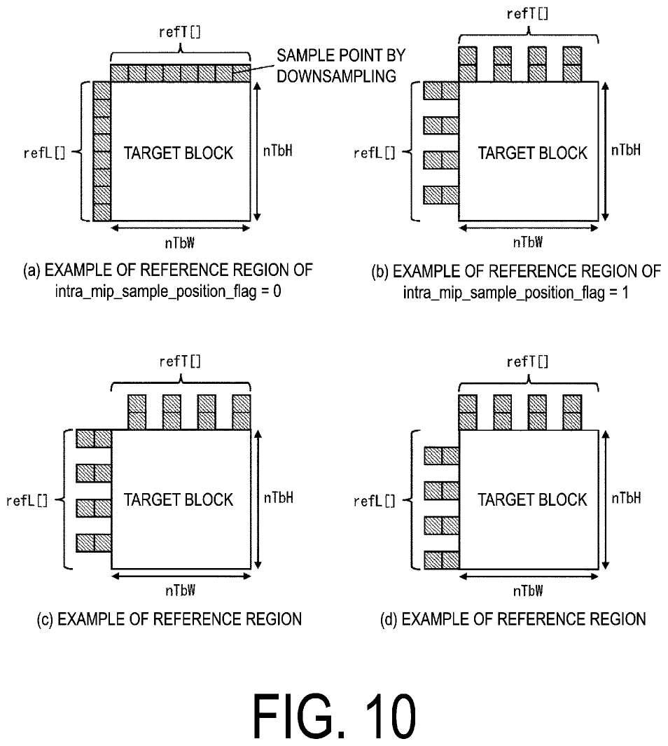

The MIP unit 31045 derives the weight matrix mWeight as a matrix having a size of (predSize*predSize)× inSize represented by m Weight [predSize*predSize][inSize]. In a case of sizeId=0 and sizeId=1, it is 16×4 matrix having predSize*predSize=16 and inSize=4, and in a case of sizeId=2, it is 64×7 matrix having predSize*predSize=64 and inSize=7. The matrix reference pixel derivation unit 4501 switches the reference region using intra_mip_sample_position_flag. FIGS. 10(a) to (d) illustrate examples of reference used by the matrix reference pixel derivation unit 4501.

FIG. 10(a) illustrates a reference region used when intra_mip_sample_position_flag is 0, and FIGS. 10(b) to (d) illustrate reference regions used when intra_mip_sample_position_flag is 1. In (a), the matrix reference pixel derivation unit 4501 sets only one line along the boundary of each neighboring block as a reference region, and in (b) to (d), sets two lines of each neighboring block as reference regions. The matrix reference pixel derivation unit 4501 may switch between a case of using a plurality of lines and a case of not using the plurality of lines in accordance with a value of a parameter (e.g., intra_mip_sample_position_flag) obtained from the coded data. Here, in the case of intra_mip_sample_position_flag=1, a plurality of lines are used, and in a case of intra_mip_sample_position_flag=0, a plurality of lines are not used. In addition, in a case that two lines are referred to, the matrix reference pixel derivation unit 4501 may refer to the same number of reference pixels as in a case that one line is referred to by referring to every other pixel as illustrated in (b).

If the reference regions shown in each of the examples are represented by coordinate values, in a case that the top left coordinate of the target block is (0,0), in (b), two lines of pixels at the position of the x coordinates 0, 2, 4, or 6 for refT and the y coordinates 0, 2, 4, or 6 for refL are referred to for refUnfilt. The reference position is not limited to this, and as illustrated in (c), two lines of pixels at a position of the x coordinates 1, 3, 5, or 7 for refT and the y coordinates 0, 2, 4, or 6 for refL may be referred to for refUnfilt. As illustrated in (d), two lines of pixels at a position of the x coordinates 0, 2, 4, or 6 for refT and the y coordinates 0, 2, 4, or 6 for refL may be referred to for refUnfilt.

In a case of intra_mip_sample_position_flag=0, the matrix reference pixel derivation unit 4501 sets the pixel values of one line adjacent to the top side in the pixel values refUnfilt[ ][ ] of the block adjacent to the target block in the first reference region refT[ ], and sets the pixel values of one column adjacent to the left side in the first reference region refL[ ].

refT[x]=refUnfilt[x][−1](x=0, . . . ,nTbW−1)

refL[y]=refUnfilt[−1][y](y=0, . . . ,nTbH−1)

At this time, the matrix reference pixel derivation unit 4501 assigns the value of the adjacent pixel value before the application of the loop filter to refUnfilt[x][y] for use. When the subscript of the top left pixel of the target block is [0][0], x=−1, y=0, . . . , nTbH−1 and x=0, . . . , nTbW−1, y=−1 are used as the ranges of the subscripts x and y.

FIG. 10(b) illustrates a reference region used by the matrix reference pixel derivation unit 4501 when intra_mip_sample_position_flag is 1. The drawing illustrates an example of the reference region in a case that the target block has 8×8 pixels (sizeId=1) and intra_mip_sample_position_flag is 1. The hatched portion indicates the reference region.

In a case that intra_mip_sample_position_flag is 1, the matrix reference pixel derivation unit 4501 sets pixel values of a plurality of lines in refUnfilt[ ][ ] of a block adjacent to the top side of the target block in the first reference region refT[ ], and sets pixel values of a plurality of columns adjacent to the left side of the target block in the first reference region refL[ ]. “Plurality” in FIG. 10(b) is an example of two lines and two columns.

```
for (i = 0; i <= 1; i++) {
  for (x = 0; x < nTbW; x++) refT[x][i] = refUnfilt[x][−1 − i]
  for (y = 0; y < nTbH; y++) refL[y][j] = refUnfilt[−1 − j][y]
}
```

Further, the increment of i++ indicating i=i+1 may be every other increment such as i=i+2(+=2) (the same applies hereinafter). The matrix reference pixel derivation unit 4501 may arrange two-dimensional pixels of a plurality of lines to make it one dimensional data and store the two-dimensional pixels in refT and refL as one-dimensional arrays. The following example is derived to arrange second columns after first columns.
for (i=0; i<=1; i++)
   for (x=0; x<nTbW; x++) refT[x/2+i*nTbW/2]=refUnfilt[x][−1−i]
for (j=0; j<=1; j++)
   for (y=0; y<nTbH; y++) refL[y/2+j*nTbH/2]=refUnfilt[−1−j][y]

Furthermore, the first columns and the second columns may be alternately arranged as described below.
for (x=0; x<nTbW; x++)
   for (i=0; i<=1; i++) refT[x+i]=refUnfilt[x][−1−i]
for (y=0; y<nTbH; y++)
   for (j=0; j<=1; j++) refL[y+j]=refUnfilt[−1−j][y]

Furthermore, subsampling may be performed by appropriately thinning out the data.
refT[xx*2+i]=refUnfilt[xx*2][−1−i](xx=x/2, x=0, . . . , nTbW−1, i=0, . . . , 1)
refL[yy*2+j]=refUnfilt[−1−j][yy*2] (yy=y/2, y=0, . . . , nTbH−1, j=0, . . . , 1)

Here, i=x % 2 and j=y % 2 may be derived as follows.
refT[x]=refUnfilt[x/2*2][−1−x % 2](x=0, . . . , nTbW−1)
refL[y]=refUnfilt[−1−y % 2][y/2*2] (y=0, . . . , nTbH−1)

Here, for refUnfilt[x][y], adjacent pixel values before application of the loop filter corresponding to the ranges of x=−2, . . . , −1, y=0, . . . , nTbH−1 and x=0, . . . , nTbW−1, y=−2, . . . , −1 are all when the subscripts of the top left pixel of the target block are [0][0]. This is expressed by the following expression.

Further, the storage method is not limited to the above expression. In a case that the data is stored while being subsampled, the data can be derived as follows. For example, for i=0, . . . , nTbW/2−1, j=0, . . . , nTbH/2−1,

$$r e fT [ i * 2 ] = r e f U n f i lt [ i * 2 ] [ - 1 ]$$

$$refT [ i * 2 + 1 ] = r e f U n f i lt [ i * 2 ] [ - 2 ]$$

$$refL [ j * 2 ] = refUnfil t [ - 1 ] [ j * 2 ]$$

$$refL [ j * 2 + 1 ] = refUnfil t [ - 2 ] [ j * 2 ]$$

Further, the order of storage may be changed.

$$r e fT [ i * 2 ] = r e f U n f i lt [ i * 2 ] [ - 2 ]$$

$$refT [ i * 2 + 1 ] = r e f U n f i lt [ i * 2 ] [ - 1 ]$$

$$refL [ j * 2 ] = refUnfil t [ - 2 ] [ j * 2 ]$$

$$refL [ j * 2 + 1 ] = refUnfil t [ - 1 ] [ j * 2 ]$$

Furthermore, the reference positions may be shifted differently at the time of subsampling.

$$refT [ i * 2 ] = r e f U n f i lt [ i * 2 ] [ - 1 ]$$

$$refT [ i * 2 + 1 ] = r e f U n f i lt [ i * 2 + 1 ] [ - 2 ]$$

$$refL [ j * 2 ] = refUnfil t [ - 1 ] [ j * 2 ]$$

$$refL [ j * 2 + 1 ] = refUnfil t [ - 2 ] [ j * 2 + 1 ]$$

The matrix reference pixel derivation unit 4501 may switch the reference region as illustrated in FIGS. 10(a) and (b) based on the flag (intra_mip_sample_position_flag) to change the reference region. The video coding apparatus according to the present example uses intra_mip_sample_position_flag to specify a reference region from which a more accurate prediction image can be obtained, so that improvement in coding efficiency can be expected. Further, the switching of the reference region is not limited to a binary flag, but may be a ternary or hither parameter.

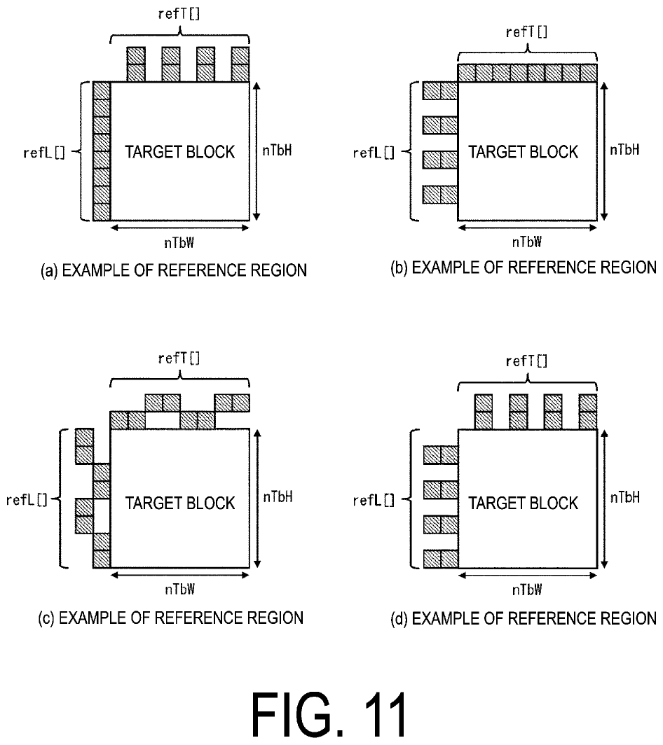

FIGS. 11(a) to (d) are examples of still other shapes of the reference region in the target block of 8×8 pixels. In a case that the top left coordinates of the target block is set to (0, 0), the matrix reference pixel derivation unit 4501 may refer to pixels at positions corresponding to two lines at the x coordinates 1, 3, 5, and 7 for refT, and pixels at positions corresponding to one line at the y coordinates 0 to 7 for refL for refUnfilt as illustrated in (a), may refer to pixels at positions corresponding to one line at x coordinates 0 to 7 for refT, and pixels at positions corresponding to two lines at y coordinates 0, 2, 4, and 6 for refL for refUnfilt, as illustrated in (b), may switch the y coordinate between −1 and −2 every two pixels with all of the x coordinates from 0 to 7 for refT, switch the x coordinate between −1 and −2 every two pixels for refL for refUnfilt, and then may refer to pixels at all positions where the y coordinates are 0 to 7, as illustrated in (c), and may refer to two lines of pixels at the positions of the x coordinates 1, 3, 5, and 7 for refT and the y coordinates 1, 3, 5, 7 for refL for refUnfilt, as illustrated in (d).

The examples of the reference region illustrated in FIGS. 10 and 11 may be freely assigned to each value of intra_mip_sample_position_flag. However, the shape of the reference region is not limited to those in the examples of FIGS. 10 and 11. For example, a reference region having a shape in which pixel positions are shifted or transposed from those in the illustrated examples, or a combination of refT and refL different from the illustrated example may be used.

FIGS. 12(a) and (b) illustrate examples of the reference regions in a case that intra_mip_sample_position_flag is 0 and 1, respectively, in a 4×4 target block (sizeId=0). The matrix reference pixel derivation unit 4501
refers to pixels at positions with the x coordinate from 0 to 3 and y coordinate of −1 for refT, and refers to pixels at positions with the x coordinate of −1 and y coordinates from 0 to 3 for refL for refUnfilt in (a), and
refers to two lines of pixels at the positions with the x coordinates of 0 and 2 for refT and pixels at the positions with the y coordinates of 0 and 2 for refL of refUntilt in (b).

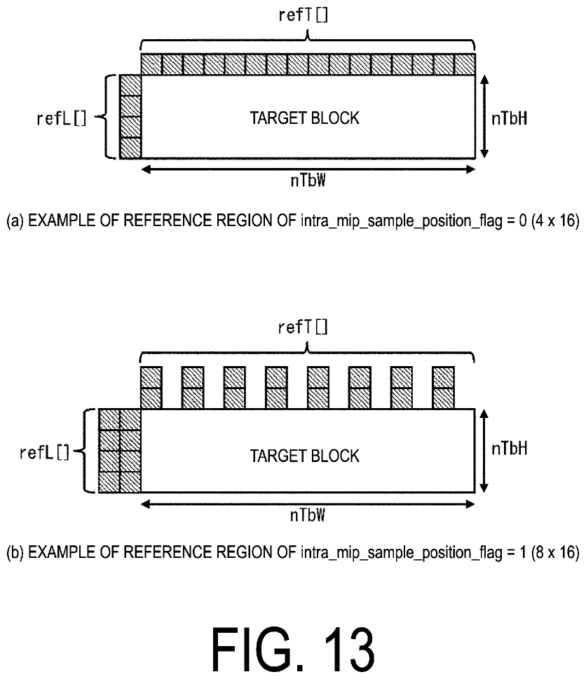

In addition, FIGS. 13(a) and (b) illustrate examples of the reference regions in a case that intra_mip_sample_position_flag is 0 and 1, respectively, in a 4×16 target block (sizeId=1). The matrix reference pixel derivation unit 4501
refers to pixels at positions with the x coordinates from 0 to 15 and y coordinate of −1 for refT, and refers to pixels at positions with the x coordinate of −1 and y coordinates from 0 to 3 for refL for refUntilt in (a), and
refers to two lines of pixels at the positions with the x coordinates of 0, 2, 4, 6, 8, 10, 12, and 14 for refT and pixels at the positions with the y coordinates of 0 to 3 for refL for refUntilt in (b).

Also in these cases, the shape of the reference regions is not limited to the illustrated shape. For target blocks of other sizes (such as 4×8, 4×32, 8×4, 8×16, 8×32, 16×16, 16×32, 32×16, and 32×32), the reference regions may be switched according to intra_mip_sample_position_flag in the same manner as in the examples described above.

### MIP Boundary Downsampling Processing

Next, the matrix reference pixel derivation unit 4501 derives second reference regions redT[x](x=0, . . . , boundarySize−1) and redL[y](y=0, . . . , boundarySize−1) by downsampling the first reference regions refT[x] and refL[y]. Since the matrix reference pixel derivation unit 4501 performs the same downsampling on refT[ ] and refL[ ], they are hereinafter referred to as refS[i](i=0, . . . , nTbS−1) and redS[i](i=0, . . . , boundarySize−1).

The matrix reference pixel derivation unit 4501 derives redT (=redS) by performing the following MIP boundary downsampling processing with refT[ ] as refS[ ] and nTbS=bTbH.

The matrix reference pixel derivation unit 4501 derives redL (=redS) by performing the following MIP boundary downsampling processing with refL[ ] as refS[ ] and nTbS=bTbW.

| if (boundarySize < nTbS) { | |
|---|---|
| bDwn = nTbS/boundarySize | (MIP-3) |

```
  for (x = 0; x < boundarySize; x++)
      redS[x] = (Σ{i = 0,..., bDwn −1} refS[x *
      bDwn + i] + (1 << Log2(bDwn) −
1))) >> Log2(bDwn)
  }
  else
    for (x = 0; x < boundarySize; x++)
      redS[x] = refS[x]
```

Here, Σ{i=a, . . . , b} is the sum from i=a to i=b.

Next, the matrix reference pixel derivation unit 4501 combines the second reference regions redL[ ] and redT[ ] to derive p[i](i=0, . . . , 2*boundarySize−1). isTransposed is set to the value of intra_mip_transposed_flag in the target block (isTransposed=intra_mip_transposed_flag).

| | |
|---|---|
| if (isTransposed == 1) | (MIP-4) |

```
  for (i = 0; i < boundarySize; i++) {
    pTemp[i] = redL[i]
    pTemp[i + boundarySize] = redT[i]
  }
else
  for (i = 0; i < boundarySize; i++) {
    pTemp[i] = redT[i]
    pTemp[i + boundarySize] = redL[i]
  }
if (sizeId == 2)
  for (i = 0; i < inSize; i++)
    p[i] = pTemp[i + 1] − pTemp[0]
else {
  p[0] = pTemp[0] − (1 << (BitDepthY − 1))
  for (i = 1; i < inSize; i++)
    p[i] = pTemp[i] − pTemp[0]
}
```

bitDepthY is the bit depth of luminance and may be, for example, 10 bits.

Further, in a case that the reference pixel cannot be referred to, the matrix reference pixel derivation unit 4501 uses the value of an available reference pixel as in intra prediction of the related art. In a case that all the reference pixels cannot be referred to, 1<< (bitDepthY−1) is used as a pixel value. In addition, since isTransposed indicates whether the prediction direction is close to vertical prediction, the pattern of mWeight[ ][ ] can be reduced to half by switching between redL and redT to be stored in the first half of p[ ] depending on isTransposed.

### (2) Prediction Processing Parameter Derivation

The prediction processing parameter derivation unit 4504 selects a weight matrix mWeight[predSize*predSize][inSize] from a set of matrices with reference to sizeId and modeId.

In a case of sizeId=0, the prediction processing parameter derivation unit 4504 selects mWeight[16][4] from an array WeightS0[16][16][4] storing the weight matrix with reference to modeId. In a case of sizeId=1, mWeight[16][8] is selected from the array WeightS1 [8][16][8] storing the weight matrix by referring to modeId. In a case of sizeId=2, m Weight [64][7] is selected from the array WeightS2 [6][64][7] storing the weight matrix by referring to modeId. These are expressed by the following expressions.

if(sizeId==0)

mWeight[i][j]=WeightS0[modeId][i][j](i=0, . . . ,15,j=0, . . . ,3)

else if(sizeId==1)

mWeight[i][j]=WeightS1[modeId][i][j](i=0, . . . ,15,j=0, . . . ,7)

else//sizeId=2

mWeight[i][j]=WeightS2[modeId][i][j](i=0, . . . ,63,j=0, . . . ,6) (MIP-5)

The prediction processing parameter derivation unit 4504 may select a weight matrix based on the selection of the reference region. For example, the prediction processing parameter derivation unit 4504 may select the weight matrix mWeight[predSize*predSize][inSize] from the set of matrices by referring to intra_mip_sample_position_flag in addition to sizeId and modeId. This makes it possible to apply an optimum weight matrix according to the difference in the reference region.

In a case of sizeId=0, the prediction processing parameter derivation unit 4504 selects mWeight[16][4] from the array WeightSOa [2][16][16][4] storing the weight matrix by referring to modeId and intra_mip_sample_position_flag. In a case of sizeId=1, mWeight[16][8] is selected from the array WeightSla [2][8][16][8] storing the weight matrix with reference to modeId and intra_mip_sample_position_flag. In the case of sizeId=2, mWeight[64][7] is selected from the array WeightS2a [2][6][64][7] storing the weight matrix with reference to modeId and intra_mip_sample_position_flag. These are expressed by the following expressions.

if(sizeId==0)

mWeight[i][j]=WeightS0a[intra_mip_sample_position_flag][modeId][i][j](i=0, . . . ,15,j=0, . . . ,3)

else if(sizeId==1)

mWeight[i][j]=WeightS1a[intra_mip_sample_position_flag][modeId][i][j](i=0, . . . ,15,j=0, . . . ,7)

else//sizeId=2

mWeight[i][j]=WeightS2a[intra_mip_sample_position_flag][modeId][i][j](i=0, . . . ,63,j=0, . . . ,6) (MIP-5a)

Thus, the weight matrix mWeight is selected.

Overlapping description about the subsequent (3) prediction pixel derivation (matrix operation) and (4) prediction pixel derivation (linear interpolation) as described above will not be repeated.

### Third MIP Example

Another example of the MIP unit 31045 will be introduced. Processing similar to that of the above-described MIP example will be omitted.

### (1) Boundary Reference Pixel Derivation

In a case that the weight matrix mWeight is derived, the MIP unit 31045 according to the present example may derive weight matrices of different sizes for target blocks of the same size (e.g., the same sizeId), and the MIP unit 31045 selects one weight matrix from weight matrix candidates having different input sizes (2*boundarySize) or different output sizes (predSizeW*predSizeH) of the weight matrix for target blocks of the same size. In addition, the input size and the output size may be selected by a parameter (e.g., intra_mip_sample_position_flag) derived from the coded data. Hereinafter, an example in which the MIP unit 31045 derives the number of pieces of input data (inSize) of the matrix prediction image derivation unit and the sizes of the intermediate prediction images (that is, predSizeW and predSizeH) such that the number of elements (predSizeW*predSizeH*inSize) of the weight matrix is constant will be described. Here, the MIP unit 31045 derives the weight matrix mWeight so that the product of the input size (2*boundarySize) and the output size (predSizeW*predSizeH) is equal with respect to the target block having the same size among the plurality of input size candidates and the plurality of output size candidates. The number of elements of the weight matrix is set to be constant for each sizeId. Accordingly, the effect of preventing the amount of calculation from increasing in some prediction modes will be exhibited.

For example, the MIP unit 31045 derives the total number num TotalMipModes of MIP modes using sizeId, and derives the sizes boundarySize of the downsampled reference regions redT[ ] and redL[ ], and the widths and heights predSizeW and predSizeH of the intermediate prediction images predMip[ ][ ] using sizeId and intra_mip_sample_position_flag.

```
numTotalMipModes = (sizeId == 0) ? 32 : (sizeId == 1) ? 16 :12
  (MIP-13)
if (intra_mip_sample_position_flag == 0) {
    boundarySize = (sizeId < 1) ? 2 : 4
    predSizeW = (sizeId <= 1) ? 4 : 8
    predSizeH = (sizeId <= 1) ? 4 : 8
} else {
    boundarySize = (sizeId = 1) ? 8 : 4
    predSizeW = (sizeId <= 1) ? 2 : 8
    predSizeH = (sizeId <= 1) ? 4 : 8
}
```

The MIP unit 31045 may derive parameters indicating the input size and the output size of the weight matrix by performing branching for each sizeId as follows.

```
if (sizeId == 0) {
  boundarySize = intra_mip_sample_position_flag ? 4 : 2
  predSizeW = intra_mip_sample_position_flag ? 2 : 4
  predSizeH = intra_mip_sample_position_flag ? 4 : 4
}
else if (sizeId == 1) {
  boundarySize = intra_mip_sample_position_flag ? 8 : 4
  predSizeW = intra_mip_sample_position_flag ? 2 : 4
  predSizeH = intra_mip_sample_position_flag ? 4 : 4
}
else if (sizeId == 2) {
  boundarySize = 4
  predSizeW = 8
  predSizeH = 8
}
```

Here, in the example of sizeId==1, the number of elements=2*boundarySize*predSizeW*predSizeH=(intra_mip_sample_position_flag? 2*4*2*4:2*4*4*4=256, which is a fixed value.

The MIP unit 31045 according to the present example sets boundarySize, predSizeW, and predSizeH to values such that the number of elements of mWeight is constant regardless of the value of intra_mip_sample_position_flag and inSize in the same size of the target block (the same sizeId).

For example, if sizeId=0 and intra_mip_sample_position_flag=0, it is a 16×4 matrix with redSizeW*predSizeH=16 and inSize=4. On the other hand, if sizeId=0 and intra_mip_sample_position_flag=1, it is a 8×8 matrix is predSizeW*predSizeH=8 and inSize=8.

That is, the MIP unit 31045 selects one weight matrix from a plurality of weight matrix candidates having different inSize, predSizeW, and predSizeH for each sizeId with respect to a target block of the same size. At this time, in a case of intra_mip_sample_position_flag=1, while inSize, which is the number of pieces of input data, is increased, predSizeW and predSizeH, which are the sizes of the intermediate prediction image, are decreased, and the number of elements of mWeight is kept the same as in the case of intra_mip_sample_position_flag=0. The same applies to sizeId=1. As a result, the effect of curbing an increase in the amount of calculation while it is enabled to derive various prediction images by switching the sample positions using intra_mip_sample_position_flag will be exhibited.

Further, although, in a case of sizeId=2, boundarySize, predSizeW, and predSizeH take constant values regardless of intra_mip_sample_position_flag in the present example, the present invention is not limited to this. As in the case that sizeId is 0 or 1, different values may be set depending on intra_mip_sample_position_flag.

Next, the matrix reference pixel derivation unit 4501 derives second reference regions redT[x](x=0, . . . , boundarySize−1) and redL[y](y=0, . . . , boundarySize−1) by downsampling the first reference regions refT[x] and refL[y]. Since downsampling is performed on refT[ ] and refL[ ] in the same manner, they are hereinafter referred to as refS[i](i=0, . . . , nTbS-1) and redS[i](i=0, . . . , boundarySize−1).

The matrix reference pixel derivation unit 4501 derives redT (=redS[ ]) by performing the same MIP boundary downsampling processing as in the first example with refT[ ] as refS[ ] and nTbS=bTbH.

The matrix reference pixel derivation unit 4501 derives redL (=redS[ ]) by performing the same MIP boundary downsampling processing as in the first example with refL[ ] as refS[ ] and nTbS=bTbW.

Here, the ratio bDwn at which downsampling processing is performed on the reference pixel stored in refS is set to ½ as compared with the first example. Thus, the matrix reference pixel derivation unit 4501 derives the input data redS twice that in the first example.

Alternatively, the matrix reference pixel derivation unit 4501 may switch the downsampling processing based on selection of a reference region. For example, the matrix reference pixel derivation unit 4501 selects downsampling processing according to intra_mip_sample_position_flag. This example is indicated below.

### MIP Boundary Downsampling Processing

if (boundarySize < nTbS) {

| | |
|---|---|
| bDwn = nTbS/boundarySize | (MIP-14) |

```
    if (intra_mip_sample_position_flag == 0) {
      for (x = 0; x < boundarySize; x++)
        redS[x] = (Σ{i = 0,..., bDwn −1} refS[x * bDwn + i] + (1 <<
Log2(bDwn) − 1))) >> Log2(bDwn)
    }
    else // intra_mip_sample_position_flag == 1
    {
      for (x = 0; x < boundarySize; x++)
        sum0 = 0, sum1 = 0, w0 = 1, w1 = 3
        for (i = 0; i < bDwn; i++) {
          if (i & 1 == 0)
            sum0 += refS[x * bDwn + i]
          else
            sum1 += refS[x * bDwn + i]
        redS[x] = (sum0 * w0 + sum1 * w1 + (1 << (Log2(bDwn) +
Log2(w0 + w1) − 1))) >> (Log2(bDwn) + Log2(w0 + w1))
    }
  }
  else
    for (x = 0; x < boundarySize; x++)
      redS[x] = refS[x]
```

Here, > {i=a, . . . , b} is the sum from i=a to i=b. In the above example, in a case that boundary Size<nTbS and intra_mip_sample_position_flag is not 0, the matrix reference pixel derivation unit 4501 performs downsampling using different weights depending on the sample position of the reference pixel. In this example, the matrix reference pixel derivation unit 4501 determines the line of the sample position based on whether i & 1==0 is satisfied based on the subscript i. That is, if i & 1==0, it is determined that refUnfilt[x][−1] or refUnfilt[−1][y] has been sampled, and if not, it is determined that refUnfilt[x][−2] or refUnfilt[−2][y] has been sampled. Although the matrix reference pixel derivation unit 4501 changes the weight based on the line of the sample position here, the classification and the conditional expression are not limited thereto. Although the weights are w0=1 and w1=3, the present invention is not limited to them, and other weights may be used.

### (2) Prediction Processing Parameter Derivation

The prediction processing parameter derivation unit 4504 selects a weight matrix mWeight[predSizeW*predSizeH][inSize] from a set of matrices with reference to sizeId and modeId.

In a case of sizeId=0, the prediction processing parameter derivation unit 4504 selects mWeight[8][8] from an array WeightSOb [16][8][8] storing the weight matrix with reference to modeId. In a case of sizeId=1, mWeight[8][16] is selected from the array WeightS1b [8][8][16] storing the weight matrix by referring to modeId. In a case of sizeId=2, m Weight [64][7] is selected from the array WeightS2b [6][64][7] storing the weight matrix by referring to modeId. These are expressed by the following expressions.

if(sizeId==0)

mWeight[i][j]=WeightS0b[modeId][i][j](i=0, . . . ,7,j=0, . . . ,7)else if(sizeId==1)

mWeight[i][j]=WeightS1b[modeId][i][j](i=0, . . . ,7,j=0, . . . ,15)else//sizeId=2

mWeight[i][j]=WeightS2b[modeId][i][j](i=0, . . . ,63,j=0, . . . ,6) (MIP-16)

In any case of sizeId, the prediction processing parameter derivation unit 4504 derives mWeight having the same number of elements as in the case of the first example. Since there is no increase in the number of pieces of input data, the effect of increasing the number of options of prediction images without increasing the amount of calculation.

As in the first example, the prediction processing parameter derivation unit 4504 may select the weight matrix mWeight[predSizeW*predSizeH][inSize] from a set of matrices by referring to intra_mip_sample_position_flag in addition to sizeId and modeId. This makes it possible to apply an optimum weight matrix according to the difference in the reference region.

In a case of sizeId=0, the prediction processing parameter derivation unit 4504 selects mWeight[8][8] from an array WeightSOc [2][16][8][8] storing the weight matrix with reference to modeId. In a case of sizeId=1, mWeight[8][16] is selected from the array

WeightS1c [2][8][8][16] storing the weight matrix by referring to modeId. In a case of sizeId=2, mWeight[64][7] is selected from the array WeightS2c [2][6][64][7] storing the weight matrix by referring to modeId. These are expressed by the following expressions.

if(sizeId==0)

mWeight[i][j]=WeightS0c[intra_mip_sample_position_flag][modeId][i][j](i=0, . . . ,15,j=0, . . . ,3)

else if(sizeId==1)

mWeight[i][j]=WeightS1c[intra_mip_sample_position_flag][modeId][i][j](i=0, . . . ,15,j=0, . . . ,7)

else//sizeId=2

mWeight[i][j]=WeightS2c[intra_mip_sample_position_flag][modeId][i][j](i=0, . . . ,63,j=0, . . . ,6) (MIP-16a)

The prediction pixel derivation processing and subsequent processing are the same as those in the first example.

### Fourth MIP Example

Another example of the MIP unit 31045 will be introduced. Processing similar to that of the above-described MIP example will be omitted.

### (1) Boundary Reference Pixel Derivation

The MIP unit 31045 according to the present example switches the downsampling method while using the same reference region. Next, by using sizeId, the MIP unit 31045 derives the total number num TotalMipModes of MIP modes, the size boundarySize of downsampled reference regions redT[ ] and redL[ ], and the width and height predSizeW and predSizeH of an intermediate prediction image predMip[ ][ ]. In the following, a case that the widths and heights of intermediate prediction images are the same, that is, a case of predSizeW=predSizeH=predSize, will be described.

num TotalMipModes=(sizeId==0)?32:(sizeId==1)?16:12

boundary Size=(sizeId==0)?2:4

predSize=(sizeId<=1)?4:8 (MIP-17)

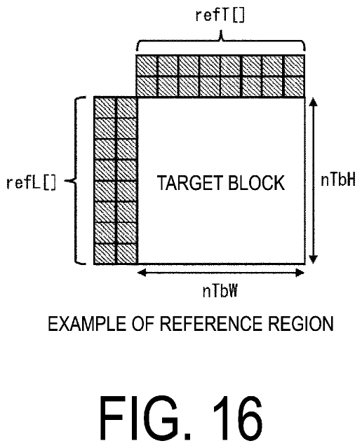

The matrix reference pixel derivation unit 4501 switches the downsampling method for the reference regions using intra_mip_sample_position_flag. FIG. 16(a) illustrates reference regions used by the matrix reference pixel derivation unit 4501 according to the present example. Although the reference regions are assumed to be the same regardless of the value of intra_mip_sample_position_flag in this example, the present invention is not limited to this. The reference regions are an example, and may be thinned out every other pixel as illustrated in FIG. 10(b), for example.

The matrix reference pixel derivation unit 4501 sets the pixel values of a plurality of lines in refUnfilt[ ][ ] of the blocks adjacent to the top side of the target block in the first reference region refT[ ], and sets the pixel values of a plurality of columns adjacent to the left side thereof in the first reference region refL[ ].

```
for (i = 0; i <= 1; i++) {
  for (x = 0; x < nTbW; x += 1) refT[x][i] = refUnfilt[x][−1 − i]
  for (y = 0; y < nTbH; y += 1) refL[y][j] = refUnfilt[−1 − j][y]
}
```

Further, the matrix reference pixel derivation unit 4501 may arrange two dimensional pixels of a plurality of lines to be one dimensional data and store the two-dimensional pixels in a one dimensional array (here, refT and refL) (the second column is arranged after the first column).
for (i=0; i<=1; i++)
   for (x=0; x<nTbW; x+=1) refT[i*nTbW+x]=refUnfilt[x][−1−i]
for (j=0; j<=1; j++)
   for (y=0; y<nTbH; y+=1) refL[j*nTbH+y]=refUnfilt[−1−j][y]

Next, the matrix reference pixel derivation unit 4501 derives second reference regions redT[x](x=0, . . . , boundarySize−1) and redL[y](y=0, . . . , boundarySize−1) by downsampling the first reference regions refT and refL. Downsampling is performed in the same manner on refT and refL, and is hereinafter referred to as refS[i][j] (i=0, . . . , nTbS-1, j=−1, . . . , 2) and redS[i](i=0, . . . , boundarySize−1) as an example using refT and refL in the case of a two dimensional array.

The matrix reference pixel derivation unit 4501 derives redT (=redS) by performing the following MIP boundary downsampling processing with refT[ ][ ] as refS[ ][ ] and nTbS=bTbH.

The matrix reference pixel derivation unit 4501 derives redL (=redS) by performing the following MIP boundary downsampling processing with refL[ ][ ] 8 as refS[ ][ ] and nTbS=bTbW.

### MIP Boundary Downsampling Processing

The matrix reference pixel derivation unit 4501 switches a set of pixels to be downsampled based on a parameter (e.g., intra_mip_sample_position_flag) derived from coded data. In the following example, the matrix reference pixel derivation unit 4501 performs downsampling using two lines (2×2 pixels) in a case of intra_mip_sample_position=0, and performs downsampling using only one line (1×4 pixels) in a case of intra_mip_sample_position=1.

| if (boundarySize < nTbS) { | |
|---|---|
| bDwn = nTbS/boundarySize | (MIP-18) |

```
    if (intra_mip_sample_position_flag == 0) {
      for (x = 0; x < boundarySize; x += bDwn)
          refS_temp[x] = refS[x][−1] + refS[x][−2]
      for (x = 0; x < boundarySize; x += bDwn)
          redS[x] = (Σ{i = 0,..., bDwn − 1}
          refS_temp[x + i][j] + (1 <<
(Log2(bDwn) − 1))) >> Log2(bDwn)
    }
    else
    {
      for (j = 0; j <= 1; j++)
        for (x = 0; x < boundarySize; x += bDwn * 2)
          redS[x * 2 + j] = (Σ{i = 0,..., bDwn * 2 − 1}
          refS[x + i][j − 2] + (1
<< (Log2(bDwn) − 1))) >> Log2(bDwn)
    }
  }
  else
    for (x = 0; x < boundarySize; x++)
      redS[x] = refS[x]
```

Here, Σ{i=a, . . . , b} is the sum from i=a to i=b.

In a case of intra_mip_sample_position=0, the matrix reference pixel derivation unit 4501 stores the sum of elements of two lines in refS_temp in the first for loop, and performs downsampling in the line in the next for loop. In a case of intra_mip_sample_position=0, for each line (outer for loop), the sum of elements of two lines is stored in refS_temp in the first for loop, and downsampling in the line is performed in the next for loop. However, the procedure of the MIP downsampling processing is not limited to the above example. For example, parallel processing may be performed by using a SIMD operation instead of a loop. By selecting the downsampling processing in accordance with intra_mip_sample_position_flag in this way, there is an effect that it is possible to derive various prediction images while curbing an increase in the amount of calculation.

Subsequent processing is similar to that in the first example.

### Configuration of Video Coding Apparatus

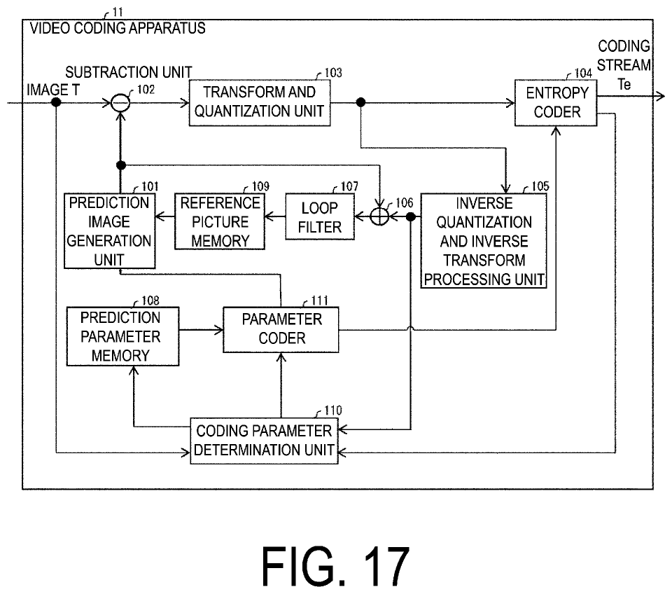

Next, a configuration of the video coding apparatus 11 according to the present embodiment will be described. FIG. 17 is a block diagram illustrating a configuration of the video coding apparatus 11 according to the present embodiment. The video coding apparatus 11 includes a prediction image generation unit 101, a subtraction unit 102, a transform and quantization unit 103, an inverse quantization and inverse transform processing unit 105, an addition unit 106, a loop filter 107, a prediction parameter memory (a prediction parameter storage unit or a frame memory) 108, a reference picture memory (a reference image storage unit or a frame memory) 109, a coding parameter determination unit 110, a parameter coder 111, and an entropy coder 104.

The prediction image generation unit 101 generates a prediction image for each CU that is a region obtained by splitting each picture of an image T. The operation of the prediction image generation unit 101 is the same as that of the prediction image generation unit 308 already described, and description thereof will be omitted.

The subtraction unit 102 subtracts a pixel value of the prediction image of a block input from the prediction image generation unit 101 from a pixel value of the image T to generate a prediction error. The subtraction unit 102 outputs the prediction error to the transform and quantization unit 103.

The transform and quantization unit 103 performs a frequency transform on the prediction error input from the subtraction unit 102 to calculate a transform coefficient, and derives a quantized transform coefficient by quantization. The transform and quantization unit 103 outputs the quantized transform coefficient to the entropy coder 104 and the inverse quantization and inverse transform processing unit 105.

The inverse quantization and inverse transform processing unit 105 is the same as the inverse quantization and inverse transform processing unit 311 (FIG. 4) of the video decoding apparatus 31, and descriptions thereof are omitted. The calculated prediction error is output to the addition unit 106.

The entropy coder 104 receives input of the quantized transform coefficient from the transform and quantization unit 103, and input of coding parameters from the parameter coder 111. The entropy coder 104 performs entropy coding on the split information, the prediction parameters, the quantized transform coefficient, and the like to generate and output a coding stream Te.

The parameter coder 111 includes a header coder 1110, a CT information coder 1111, a CU coder 1112 (prediction mode coder), an inter prediction parameter coder 112, and an intra prediction parameter coder 113 that are not illustrated. The CU coder 1112 further includes a TU coder 1114.

### Configuration of Intra Prediction Parameter Coder 113

The intra prediction parameter coder 113 derives a format for coding (e.g., intra_luma_mpm_idx, intra_luma_mpm_remainder, and the like) from IntraPredMode input from the coding parameter determination unit 110. The intra prediction parameter coder 113 includes a partly identical configuration to a configuration in which the intra prediction parameter decoder 304 derives the intra prediction parameters.

The addition unit 106 adds a pixel value of the prediction image of the block input from the prediction image generation unit 101 and the prediction error input from the inverse quantization and inverse transform processing unit 105 for each pixel to generate a decoded image. The addition unit 106 stores the generated decoded image in the reference picture memory 109.

The loop filter 107 applies a deblocking filter, an SAO, and an ALF to the decoded image generated by the addition unit 106. Further, the loop filter 107 need not necessarily include the above-described three types of filters, and may have a configuration of only the deblocking filter, for example.

The prediction parameter memory 108 stores the prediction parameters generated by the coding parameter determination unit 110 for each target picture and CU at a predetermined position.

The reference picture memory 109 stores the decoded image generated by the loop filter 107 for each target picture and CU at a predetermined position.

The coding parameter determination unit 110 selects one set among a plurality of sets of coding parameters. The coding parameters are QT, BT, or TT split information described above, a prediction parameter, or parameters to be coded which are generated related thereto. The prediction image generation unit 101 generates a prediction image by using these coding parameters.

The coding parameter determination unit 110 calculates, for each of the plurality of sets, an RD cost value indicating the magnitude of the amount of information and a coding error. The coding parameter determination unit 110 selects a set of coding parameters of which the calculated cost value is a minimum value. In this manner, the entropy coder 104 outputs a selected set of coding parameters as a coding stream Te. The coding parameter determination unit 110 stores the determined coding parameters in the prediction parameter memory 108.

Further, some of the video coding apparatus 11 and the video decoding apparatus 31 in the above-described embodiments may implement, with a computer, for example, the entropy decoder 301, the parameter decoder 302, the loop filter 305, the prediction image generation unit 308, the inverse quantization and inverse transform processing unit 311, the addition unit 312, the prediction image generation unit 101, the subtraction unit 102, the transform and quantization unit 103, the entropy coder 104, the inverse quantization and inverse transform processing unit 105, the loop filter 107, the coding parameter determination unit 110, and the parameter coder 111. In that case, this configuration may be realized by recording a program for realizing such control functions on a computer-readable recording medium and causing a computer system to read the program recorded on the recording medium for execution. Further, the “computer system” described here refers to a computer system built into either the video coding apparatus 11 or the video decoding apparatus 31 and is assumed to include an OS and hardware components such as a peripheral apparatus. A “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically retains the program for a short period of time, such as a communication wire that is used to transmit the program over a network such as the Internet or over a communication line such as a telephone line, and a medium that retains the program for a certain period of time, such as a volatile memory within the computer system which functions as a server or a client in a case that the program is transmitted via the communication wire. Furthermore, the aforementioned program may be configured to implement part of the functions described above, and also may be configured to be capable of implementing the functions described above in combination with a program already recorded in the computer system.

In addition, some or all of the video coding apparatus 11 and the video decoding apparatus 31 in the embodiment described above may be realized as integrated circuits such as a large-scale integration (LSI). Each function block of the video coding apparatus 11 and the video decoding apparatus 31 may be individually realized as processors, or some or all thereof may be integrated into processors. In addition, the circuit integration technique is not limited to LSI, and may be realized as dedicated circuits or a multi-purpose processor. Furthermore, in a case that advances in the semiconductor technology lead to the advent of a circuit integration technology that replaces LSI, an integrated circuit based on the technology may be used.

Although the embodiments of the present invention have been described in detail above referring to the drawings, the specific configuration is not limited to the above embodiment, and various amendments can be made to a design that fall within the scope that does not depart from the gist of the present invention.

### Application Examples

The above-mentioned video coding apparatus 11 and video decoding apparatus 31 can be utilized being installed in various apparatuses that perform transmission, reception, recording, and reproduction of videos. Further, the video may be a natural video imaged by a camera or the like, or may be an artificial video (including CG and GUI) generated by a computer or the like.

The embodiments of the present invention are not limited to the above-described embodiments, and various modifications can be made within the scope of the claims. That is, an embodiment obtained by combining technical means modified appropriately within the scope of the claims is also included in the technical scope of the present invention.

### INDUSTRIAL APPLICABILITY

The embodiments of the present invention can be preferably applied to a video decoding apparatus that decodes coded data in which image data is coded, and a video coding apparatus that generates coded data in which image data is coded. Furthermore, the embodiments of the present invention can be preferably applied to a data structure of coded data generated by the video coding apparatus and referred to by the video decoding apparatus.

### REFERENCE SIGNS LIST

31 Image decoding apparatus
301 Entropy decoder
302 Parameter decoder
303 Inter prediction parameter decoder
304 Intra prediction parameter decoder
308 Prediction image generation unit
309 Inter prediction image generation unit
310 Intra prediction image generation unit
311 Inverse quantization and inverse transform processing unit
312 Addition unit
31045 MIP unit
4501 Matrix reference pixel derivation unit
4502 Matrix prediction image derivation unit
4503 Mode derivation unit
4504 Prediction processing parameter derivation unit
4505 Matrix prediction image interpolation unit
11 Image coding apparatus
101 Prediction image generation unit
102 Subtraction unit
103 Transform and quantization unit
104 Entropy coder
105 Inverse quantization and inverse transform processing unit
107 Loop filter
110 Coding parameter determination unit
111 Parameter coder
112 Inter prediction parameter coder
113 Intra prediction parameter coder
1110 Header coder
1111 CT information coder
1112 CU coder (prediction mode coder)
1114 TU coder

1. A video decoding apparatus, comprising:
a matrix reference pixel derivation circuit configured to derive, as a reference image, an image obtained by downsampling an image adjacent to a top side and a left side of a target block;
a mode derivation circuit configured to derive a candidate list of prediction modes used for a target block according to the reference image and a size of the target block;
a prediction processing parameter derivation circuit configured to derive a prediction processing parameter used to derive a prediction image according to the candidate list, a matrix intra prediction mode indicator, and the size of the target block;
a matrix prediction image derivation circuit configured to derive a prediction image based on an element of the reference image and the prediction processing parameter; and
a matrix prediction image interpolation circuit configured to derive the prediction image or an image obtained by interpolating the prediction image as a prediction image,
wherein the mode derivation circuit derives a candidate list having the number of elements equal to or less than half the total number of prediction modes defined for the size of the target block, and
wherein the mode derivation circuit derives the candidate list based on (1) a feature value derived from pixel values included in the reference image by using an arithmetic operation of any one of an average, a difference, and an absolute value, or (2) a magnitude relationship between the feature value and a threshold.

2.-3. (canceled)

4. The video decoding apparatus according to claim 1, wherein the mode derivation circuit derives the candidate list by using a prediction mode or a quantization parameter of a neighboring block.

5. A video coding apparatus, comprising:
a matrix reference pixel derivation circuit configured to derive, as a reference image, an image obtained by downsampling an image adjacent to a top side and a left side of a target block;
a mode derivation circuit configured to derive a candidate list of prediction modes used for a target block according to the reference image and a size of the target block;
a prediction processing parameter derivation circuit configured to derive a prediction processing parameter used to derive a prediction image according to the candidate list, an intra prediction mode, and the size of the target block;
a matrix prediction image derivation circuit configured to derive a prediction image based on an element of the reference image and the prediction processing parameter; and
a matrix prediction image interpolation circuit configured to derive the prediction image or an image obtained by interpolating the prediction image, as a prediction image,
wherein the mode derivation circuit derives a candidate list having the number of elements equal to or less than half the total number of prediction modes defined for the size of the target block, and
wherein the mode derivation circuit derives the candidate list based on (1) a feature value derived from pixel values included in the reference image by using an arithmetic operation of any one of an average, a difference, and an absolute value, or (2) a magnitude relationship between the feature value and a threshold.

6.-11. (canceled)

12. A video decoding apparatus, comprising:
a matrix reference pixel derivation circuit configured to derive, as a reference image, an image obtained by downsampling an image adjacent to a top side and a left side of a target block;
a mode derivation circuit configured to derive a candidate list of prediction modes used for a target block according to the reference image and a size of the target block;
a prediction processing parameter derivation circuit configured to derive a prediction processing parameter used to derive a prediction image according to the candidate list, a matrix intra prediction mode indicator, and the size of the target block;
a matrix prediction image derivation circuit configured to derive a prediction image based on an element of the reference image and the prediction processing parameter; and
a matrix prediction image interpolation circuit configured to derive the prediction image or an image obtained by interpolating the prediction image as a prediction image,
wherein the mode derivation circuit derives a candidate list having the number of elements equal to or less than half the total number of prediction modes defined for the size of the target block, and
wherein the mode derivation unit derives the candidate list based on a magnitude relationship between a pixel value and a pixel value included in the reference image or a magnitude relationship between a pixel value and a threshold.
